(19) United States
(12) Patent Application Publication
(10) Pub. No.: US 2013/0067208 A1
(43) Pub. Date: Mar. 14, 2013

(54) SYSTEM AND METHOD FOR DYNAMICALLY CONFIGURING A MOBILE DEVICE APPLICATION

(71) Applicants: Mark BRINKMAN, FLOWER MOUND, TX (US); Raymond J. MIMICK, COPPELL, TX (US); Kary B. KELLOGG, CARROLLTON, TX (US)

(72) Inventors: Mark BRINKMAN, FLOWER MOUND, TX (US); Raymond J. MIMICK, COPPELL, TX (US); Kary B. KELLOGG, CARROLLTON, TX (US)

(73) Assignee: BRINKMAN FINANCIAL COMPANY, L.P., Carrollton, TX (US)

(21) Appl. No.: 13/228,110

(22) Filed: Sep. 8, 2011

(51) Int. Cl. G06F 9/00

(52) U.S. Cl. 713/1

(57) ABSTRACT

An improved system and method are disclosed for configuring a behavior of an application on a mobile device via configuration parameters maintained by an application control program provided on a network accessible platform that is separate from the mobile device. In one example, the method enables the application control program to configure and dynamically modify parameters for a particular application that may also be used as a stand-alone application on the mobile device.

### BACKGROUND

Communication devices, whether wired or wireless, typically use applications to provide functionality to users. Such applications are frequently downloaded or otherwise stored in the memory of such devices and accessed when needed by the user. An application may be associated with various parameters on the device and at least some of the parameters may be configured to control the application's behavior. However, current application configuration methods generally lack flexibility. Accordingly, what is needed are a system and method that address these issues.

### BRIEF DESCRIPTION OF THE DRAWINGS

For a more complete understanding, reference is now made to the following description taken in conjunction with the accompanying Drawings in which:

FIG. 1 is a simplified network diagram of one embodiment of an environment in which mobile devices are in communication with an application control program (ACP).

FIG. 2 is a sequence diagram illustrating one embodiment of a message sequence that may occur in the environment of FIG. 1 between a mobile device and the ACP.

FIG. 3 is a flow chart illustrating one embodiment of a method that may be used to upload and configure an application in the environment of FIG. 1.

FIG. 4 is a flow chart illustrating one embodiment of a method that may be used to modify the configuration of an application in the environment of FIG. 1.

FIG. 5 is a diagram of one embodiment of a hierarchical control structure.

FIG. 6 is a flow chart illustrating one embodiment of a method that may be used to upload an application for control by the ACP in the environment of FIG. 1.

FIG. 7 is a sequence diagram illustrating an embodiment of a message sequence that may be used to define and execute a hierarchical authorization structure for a particular application on a mobile device within the environment of FIG. 1.

FIG. 8 is a flow chart illustrating one embodiment of a method that may be used to provide the hierarchical structure of FIG. 7.

FIG. 9 is a sequence diagram illustrating one embodiment of a message sequence that may occur in the environment of FIG. 1 to provide a mobile device with access to one of a plurality of accounts controlled by the ACP.

FIG. 10 is a sequence diagram illustrating another embodiment of a message sequence that may occur in the environment of FIG. 1 to provide a mobile device with access to one of a plurality of accounts controlled by the ACP.

FIG. 11 is a flow chart illustrating one embodiment of a method that may be used to provide accounts and account configuration information to the ACP of FIG. 1.

FIGS. 12A-12D are diagrams illustrating embodiments of mobile device displays showing different account configurations that may be created by the method of FIG. 11.

FIG. 13 is a flow chart illustrating one embodiment of a method that may be used by a mobile device of FIG. 1 to select one of a plurality of accounts controlled by the ACP.

FIG. 14 is a flow chart illustrating one embodiment of a method that may be used to provide a selected account from the ACP of FIG. 1 to a mobile device.

FIGS. 15A and 15B are diagrams illustrating different embodiments of account handling that may be performed by the ACP of FIG. 1.

FIG. 16 is a simplified network diagram of one embodiment of an environment in which a mobile device is coupled to a gateway server and a merchant.

FIG. 17 is a sequence diagram illustrating an embodiment of a message sequence that may occur in the environment of FIG. 16 to conduct a transaction using an electronic wallet application.

FIG. 18 is a sequence diagram illustrating an embodiment of a message sequence that may occur in the environment of FIG. 1 to interact with a lifestyle communications controller.

FIG. 19 is a diagram of one embodiment of a computer system that may be used in the environments of FIG. 1 and FIG. 16.

### DETAILED DESCRIPTION

The present disclosure is directed to a system and method for an architecture capable of remotely configuring, supporting, and controlling an application on a mobile device. It is understood that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

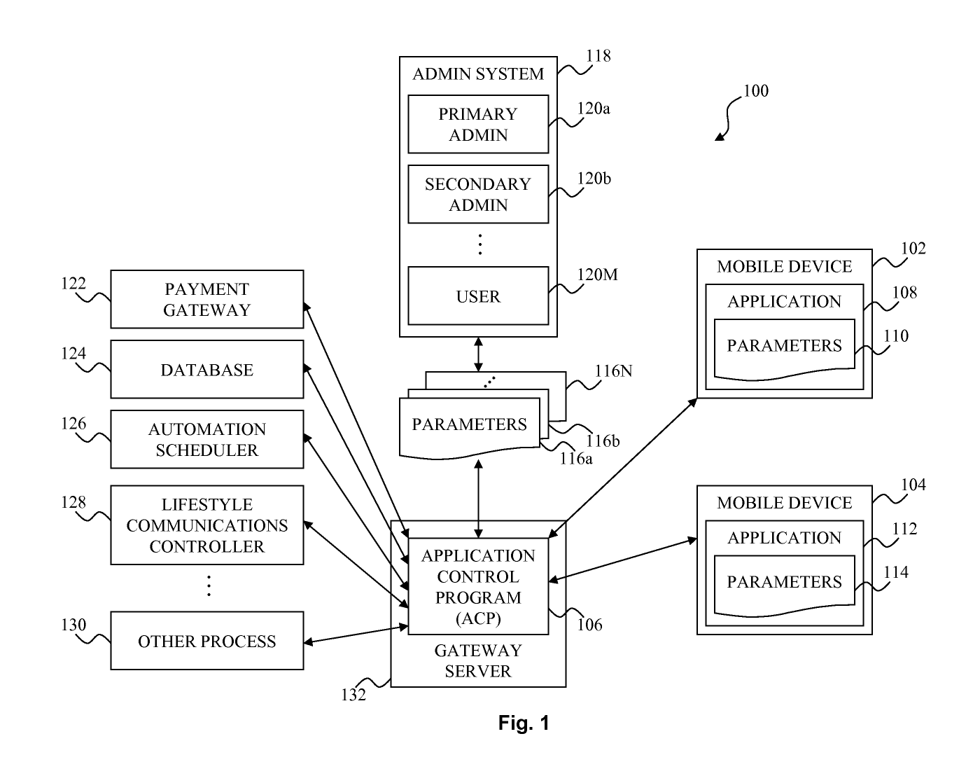

Referring to FIG. 1, in one embodiment, an environment 100 is illustrated with mobile devices 102 and 104 coupled to an application control program (ACP) 106. Examples of such mobile devices include cellular telephones (including smart phones), personal digital assistants (PDAs), netbooks, tablets, laptops, desktops, workstations, and any other computing device that can communicate with the ACP 106 using a wireless communication link. Such communications may be direct (e.g., via a peer-to-peer network, an ad hoc network, or using a direct connection), indirect, such as through a server or other proxy (e.g., in a client-server model or a cellular network), or may use a combination of direct and indirect communications. All the examples herein are directed to the use of mobile devices, it is understood that the described functionality may also be applied to wired devices.

The device 102 includes an application 108. The application 108 provides a user of the device 102 with the ability to interact with the device 102 in order to perform tasks in such areas as communication (e.g., voice and/or video calls, email, and text messaging), scheduling, gaming, Internet access, and financial transactions (e.g., viewing, selecting, and purchasing merchandise and services and/or making donations). The application 108 may be controlled by parameters 110 that are stored on the device 102 and/or parameters 116a that are stored elsewhere and are accessible to the ACP 106. The parameters 110 may be entered by a user of the device 102 and/or may be modified and controlled by the parameters 116a. The parameters 116a may be modified via an administration (admin) system 118 as will be described in greater detail below.

The device 104 includes an application 112. The application 112 provides a user of the device 104 with the ability to interact with the device 104 in order to perform tasks in such areas as communication (e.g., voice and/or video calls, email, and text messaging), scheduling, gaming, Internet access, and financial transactions (e.g., viewing, selecting, and purchasing merchandise and services and/or making donations). The application 112 may be controlled by parameters 114 that are stored on the device 104 and/or parameters 116b that are stored elsewhere and are accessible to the ACP 106. The parameters 114 may be entered by a user of the device 104 and/or may be modified and controlled by the parameters 116b. The parameters 116b may be modified via the admin system 118.

Generally, an application such as the application 108 and/or 112 tends to be either a stand-alone application or a server-managed application. Moreover, once an application is released to the public (e.g., is not controlled in an enterprise or other structured environment), the ability to manage and control the application tends to become more limited. For example, there are stand-alone applications that provide basic functionality and offer additional functionality for a price. Once unlocked (e.g., upgraded), which is often done by entering a key into the application on the mobile device, the additional functionality becomes available to the user. Access to the functionality may be controlled on the device for that particular application, but this approach does not provide any structured hierarchical control or configuration mechanism that can be widely applied to the application across a variety of devices and/or to a variety of users that may or may not be related other than by use of the application.

The environment 100 provides a system by which an application such as the application 108/112 can be released to a wide group of users in an unstructured environment and managed remotely using a hierarchical control structure. This is accomplished using the admin system 118 that enables a control hierarchy to be established and maintained via the parameters 116a-116N and ACP 106. The control hierarchy allows a higher level user to select and set a feature and then lock the selection down for any lower level user, thereby defining not only required application behavior, but also the configuration flexibility provided to lower levels of the hierarchy.

The admin system 118 may also link the application to multiple backend processes via the ACP 106 and then define the configuration of the various processes, providing a great deal of flexibility. For purposes of the example, the backend processes include a payment gateway 122, a database 124, an automation scheduler 126, a lifestyle communications controller 128, and any other process 130. The payment gateway 122 may link the ACP 106 to one or more credit card processors, banks, and other financial institutions. The database 124 may be a specialized database (e.g., containing scientific or technical articles) or may be any database to which the application 108 wants to connect. The automation scheduler 126 may allow the application 108 to access and control automation functions in order to automate whatever process or processes are controlled by the scheduler. The lifestyle communications controller 128 may be used to couple the application 108 to a house, vehicle, or another structure to provide monitor and control functions. The backend processes 122-130 may be operated by third parties or may be operated by the same operator as the admin system 118/ACP 106.

It is understood that the applications 108/112 may be configured to access different ones of the backend processes 122-130. For example, the application 102 may be a payment application that uses the payment gateway 122, while the application 112 may be a home automation application that uses the lifestyle communications controller 128. In other embodiments, the applications 108/112 may be the same but access the backend process in different ways. For example, the user of the device 102 may provide the ACP 106 with a particular username and password for a backend process (e.g., the lifestyle communications controller 128) and the user of the mobile device 104 may provide the ACP 106 with a different username and password for the same backend process. The ACP 106 would then provide each user with information from the lifestyle communications controller 128 corresponding to their unique username and password.

Providing the control afforded by the admin system 118 to a particular application 108/112 may be accomplished in a relatively automated manner using, for example, extensible markup language (XML) functionality to define application control features. The admin system 118 may then generate graphical user interfaces (GUIs), database tables, and other control components based on the XML. Interaction with the backend processes 122-130 may be based on known application programming interfaces (APIs). In the present example, the ACP 106 handles interactions between the processes 122-130 and the applications 108/112. In other embodiments, the applications 108/112 may communicate directly with the processes 122-130 while controlled by the ACP 106 via the parameters 116a/116b.

The ACP 106 is a program that may be run on a gateway server 132 or another network component that is accessible the devices 102 and 104. The ACP may be configured via the admin system 118 to control the functionality of the applications 108 and 112. The parameters 116a-116N may be part of the ACP 106 or may be otherwise accessible to the ACP 106, such as being stored in a database (not shown) that is accessible to the ACP 106.

The admin system 118 provides a hierarchical, application-specific control structure that may be established and enforced via the ACP 106 for applications that log into the ACP 106, even though the ACP 106 has no control over other applications on the devices 102 and 104. This enables a maximum level of control to be maintained via the ACP 106 when no other control is possible over the devices 102 and 104. As the control is application specific, configuration parameters may be changed as desired without affecting the devices themselves. It is understood that this control may be exerted on the applications 108 and 112 in stand-alone mode if the ACP 106 is able to change the respective local parameters 110 and 114. If the local parameters 110 and 114 cannot be changed by the ACP 106 (e.g., if the devices 102 and 104 do not permit local changes to occur), the ACP 106 may be limited to controlling functionality provided during online operation when the applications 108 and 112 are logged into the ACP 106.

The ACP 106 may be provided on a network accessible platform such as the gateway server 132. The gateway server 132 may also include the parameters 116a-116N and/or the admin system 118 in some embodiments. It is understood that many different network accessible platforms may be used to operate the ACP 106 and the gateway server 132 is used herein as representing all such platforms. Accordingly, the ACP 106, parameters 116a-116N, the gateway server 132 (or any other network accessible platform), and/or the admin system 118 may be viewed as a system that is configured to provide the functionality described herein within the environment 100. It is understood that such a system may be configured in many different ways with many different components, and may include multiple load-balancing servers, mirrors, reflectors, and other components not described in detail herein.

It is understood that the sequence diagrams and flow charts described herein illustrate various exemplary functions and operations that may occur within various communication environments. It is understood that these diagrams are not exhaustive and that various steps may be excluded from the diagrams to clarify the aspect being described. For example, it is understood that some actions, such as network authentication processes and notifications, may have been performed prior to the first step of a sequence diagram by one or both of the mobile devices 102 and 104. Such actions may depend on the particular type and configuration of each device 102 and 104, including how network access is obtained (e.g., cellular or WLAN access). Other actions may occur between illustrated steps or simultaneously with illustrated steps, including network messaging for call maintenance (including handoffs), communications with other devices (e.g., email, text messages, and/or voice calls (including conference calls)), and similar actions.

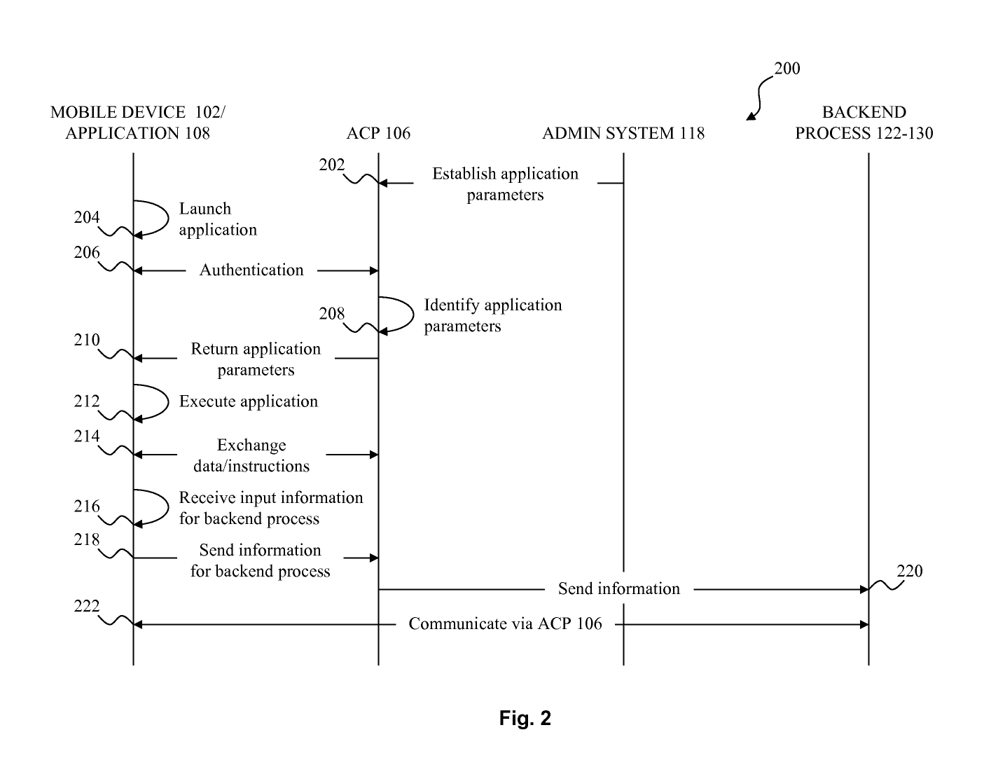

Referring to FIG. 2, a sequence diagram illustrates one embodiment of a message sequence 200 that may occur in the environment of FIG. 1 to dynamically control the application 108 on the device 102 of FIG. 1 via the ACP 106. In other words, the parameters 116a may be set by the admin system 118 to control the behavior of the application 108. Based on the configuration of the application 108, this control may determine when the application 108 can be launched, may define some or all of the functionality of the application 108 after it is launched and/or the functionality of the application 108 during online operation (i.e., as opposed to standalone operation), and may otherwise define the behavior of the application 108.

In the present example, the developer of the application 108 would like to define the behavior of the application 108 for control by the ACP 106. The ACP 106 may be provided by the developer or by another party, such as a service provider or the operator of an online application store through which the application 108 is to be provided to the public. In such cases, the developer may not personally control the ACP 106 and may interact with the ACP 106 using an interface provided by the operator of the ACP 106. For example, the operator of the ACP 106 may provide a process by which the developer can upload the application 108 and define the application's behavior.

Accordingly, in step 202, the developer establishes application parameters for the application 108. The application 108 may have been previously uploaded or the application 108 may be uploaded as part of step 202.

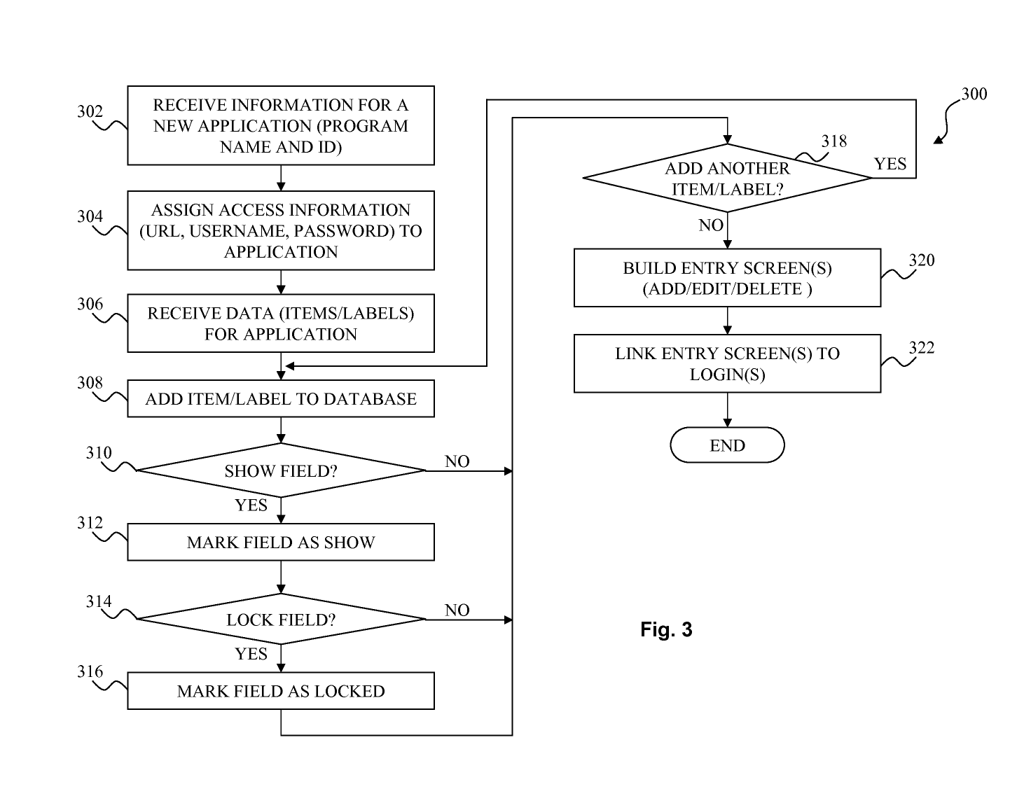

With additional reference to FIG. 3, a method 300 illustrates one embodiment of a process by which the application 108 may be uploaded and parameters for the application established (e.g., as shown in step 202 of FIG. 2). The method 300 may be largely automated to receive information in a defined format and generate access information, interfaces, and settings based on the received information. The method 300 may be executed by part of the system operating within the environment 100 of FIG. 1, such as by the gateway server 132 that may also support the ACP 106 and admin system 118. Alternatively, a separate component of the system operating within the environment 100 of FIG. 1 may be used to handle the method 300, and the information may be transferred to another component once the method 300 is complete. Accordingly, the system operating within the environment 100 of FIG. 1 may be configured to perform the method 300 in many different ways. For purposes of example, the gateway server 132 is configured to handle the method 300 via the ACP 106.

Although not shown in FIG. 3, the system operating within the environment 100 of FIG. 1 may be configured to provide a portfolio for the developer and the portfolio may be associated with authentication information corresponding to the developer, such as a unique user identifier (user ID) and password. The portfolio may contain multiple applications uploaded by the developer. In other embodiments, the system operating within the environment 100 of FIG. 1 may not provide a portfolio and the developer may have a unique user ID and password for each uploaded application. Accordingly, prior to step 302, the developer may log into the gateway server and gain access to the corresponding portfolio and the tools provided for handling the addition of a new application.

In step 302, information is received for a new application (e.g., the application 108). The information may include a name for the application 108 (e.g., a name usable by the developer and system to easily identify the application 108 and/or a name to be listed in the online application store) and a unique ID for the application. The ID may be provided by the developer or may be generated by the method 300.

In step 304, access information is assigned to the application 108. The access information may include an address such as a uniform resource locator (URL), a username, and a password needed by the application 108 to communicate with the ACP 106. For example, the URL may provide a network address to which the application 108 can send messages, and the username and password may be used by the application 108 to identify the application 108 to the ACP 106 for authentication purposes.

In step 306, the gateway server 132 receives data for the application 108. The data may be formatted in a defined manner to provide items, labels, and other information that is used to generate the interfaces needed to provide control of the application 108. For example, assume that the application 108 is to be used for remotely controlling a home automation system. The received data may define automation system components such as a heating/ventilation/air conditioning (HVAC) system, a lighting system, an alarm system, a refrigeration system, a sprinkler system, window shades, a coffee maker, and/or other automated components. Each component may be associated with one or more control features, such as heat/air for the HVAC system. These control features may in turn be associated with control features, such as a temperature. In an alternative embodiment, the application 108 may be configured to handle financial transactions. The received data may define transaction types (e.g., checks and credit cards), and each transaction type may be associated with control features. For example, a credit card may have a toggle for “swipe required,” a field for “maximum transaction amount,” a geographic location requirement that only permits transactions to occur within a defined geographic location, a time requirement that only permits transactions to occur within a defined period of time (e.g., from 8:00 AM to 5:00 PM) on weekdays, and a language display selector (e.g., English or Spanish).

In step 308, each item/label is added to a database table that is built based on the XML upload from the developer. A single table may be used for the application 108 or multiple tables may be created for a single application (e.g., one table for application settings and one or more other tables for data storage).

In step 310, a determination is made as to whether the field for a particular item is to be shown. For example, for the financial transactions, the “swipe required” field may have the option of being shown or hidden on the device 102. If the field is to be shown, the method 300 marks the field as shown in step 312 and continues to step 314. In step 314, a determination is made as to whether the field is to be locked. For example, if the developer locks the field (e.g., selects “yes” as the lock choice), then no lower level user can override the lock to force the application 108 to not require a credit card swipe. If the field is to be locked, the method 300 moves to step 316 where the field is marked as locked. If the determination of step 310 indicates that the field is not to be shown, or if the determination of step 314 indicates that the field is not to be locked, or after step 316 is executed, the method 300 moves to step 318.

In step 318, a determination is made as to whether there is another item/label to add. If there is another item/label to add, the method 300 returns to step 308. If not, the method 300 continues to step 320, where one or more entry screens are built. For example, if the upload data does not indicate more levels than a top level developer screen, only the top level screen may be build. The screen may provide interactive features to allow the developer to perform such functions as adding, editing, and deleting existing items/labels and/or hierarchical control levels. In step 322, any entry screens are linked to a corresponding login. For example, the top level entry screen may be linked to the developer's login and lower level entry screens may be linked to other defined logins.

The items/labels stored in the database result in the parameters 116a. Some or all of these parameters 116a may be transferred to the device 102 as parameters 110. For example, if a credit card swipe is required, this parameter may be transferred to the device 102 to prevent any credit card transaction without a swipe. In other embodiments, the parameter may not be transferred to the device 102, but the application 108 may not be capable of performing a credit card transaction without being logged into the ACP 106. In this case, the parameter may be enforced by the ACP 106 when the application 108 logs in.

As will be described in following embodiments, the parameters 116a-116N may be used for a variety of dynamic configuration purposes, and the configuration may be the same or different for the devices 102 and 104. For example, the parameters 116a may be used to individualize the presentation of information by the application 108 on the device 102, such as branding a logo and color theme. The parameters 116a may be used to load multiple merchant accounts on the device 102. The parameters 116a may be used to set and lock individual application settings in a multiple hierarchy structure. The parameters 116a may provide the ability to push notifications from the admin system (e.g., send a message to an individual user, a subset of users, or all users) in real time dependent on criteria such as a user identifier (ID) and user location. The parameters 116a may be used to define certain behaviors such as, when accepting a check for payment, using a camera of the device 102 to take a picture of the check before digitizing the image to automatically extract the data and fill in the check data (e.g., routing number, account number, bank name, customer name, address, city, state, zip, and telephone number). The parameters 116a may provide the ability to control the maximum dollar amount entered on the device 102 for a single transaction, a daily total transaction volume, a monthly total transaction volume, an annual transaction volume, and/or a customer's total transaction volume by day, week, month, year, and/or event. The parameters 116a may provide the ability to limit the device 102 from processing transactions by the location of the device, such as a limit within or outside of a given area or location such as an area like a city, a state, or a country, or based on other criteria, such as a period of time.

Referring to FIG. 4, a method 400 illustrates one embodiment of a process by which the various parameters of the application 108 may be modified. In the present example, the application 108 has been previously uploaded as described with respect to FIG. 3 and the database tables have been created. The method 400 may be used for a new application that has been uploaded or for an application that has been released and is in use. Changes made to the parameters 116a/110 via the admin system 118 may alter the behavior of the application 108 once the application 108 logs into the ACP 106.

In step 402, a user logs into the admin system 118. The login information may be used to determine which hierarchical level the user is associated with and so may determine which parameters can be altered by the user. In the present example, the user is the primary admin (e.g., the developer) and has the ability to view, modify, and lock all parameters. For purposes of illustration, the financial transaction example of the application 108 is continued with entries for “swipe required,” “maximum transaction amount,” the geographic location requirement, the time requirement, and the language display selector.

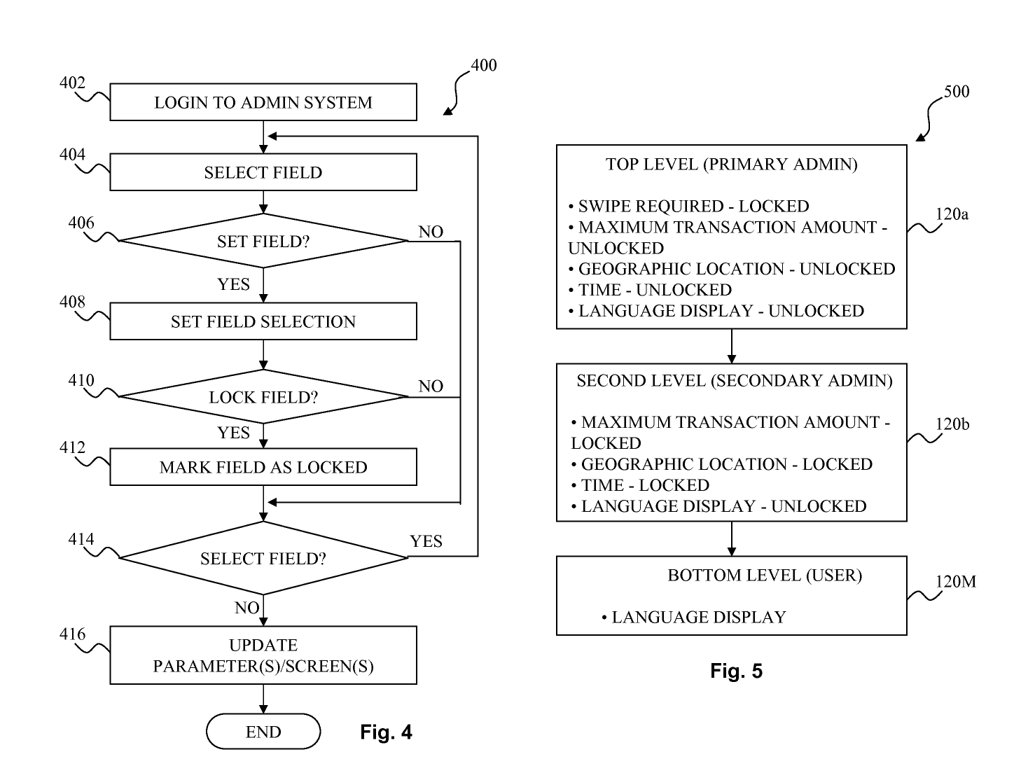

With additional reference to FIG. 5, one embodiment of a hierarchical control structure 500 is illustrated with the primary admin level 120a, secondary admin level 120b, and bottom user level 120M of FIG. 1. The primary admin login of step 402 enables the developer to view the primary admin level 120a.

In step 404 of FIG. 4, the primary admin selects the “swipe required” field. In step 406, a determination is made as to whether the field is to be set (e.g., assigned a particular value). If the field is not to be set, the method 400 continues to step 414. However, in the present example, the field is to be set and the method 400 continues to step 408, where the field is set to require a swipe (e.g., the field may be set to “Yes”). In step 410, a determination is made as to whether the field is to be locked. If the field is not to be locked, the method 400 continues to step 414. However, in the present example, the field is to be locked and the method 400 continues to step 412, where the field is marked as locked. This means that lower levels of the hierarchy cannot alter the “swipe required” setting.

The method 400 then continues to step 414, where a determination is made as to whether another field is selected. If another field is selected, the method 400 returns to step 404. In the present example, no other field is selected and the “maximum transaction amount,” the geographic location requirement, the time requirement, and the language display selector remain unset and unlocked. If no other field is selected, the method 400 continues to step 416, where parameter(s) and/or screen(s) may be updated to reflect any changes made. For example, the parameters 116a may be updated to indicate that the “swipe required” field has been set to require a swipe and cannot be modified by users under the primary admin level. Screens may also be updated for lower level users to indicate the locked “swipe required” field. It is understood that updating a screen may be included in updating the parameter(s) if the screen is dynamically generated at login based on the parameters.

Returning to step 402, another login occurs using authentication information for the secondary admin, who has the ability to view, modify, and lock all parameters not locked by the primary admin. For purposes of illustration, the entry for “swipe required” is locked and the entries for “maximum transaction amount,” the geographic location requirement, the time requirement, and the language display selector are unlocked. Referring again to FIG. 5, the secondary admin level 120b is illustrated with the four unlocked fields. It is understood that the locked “swipe required” field may also be shown but cannot be modified by the secondary admin.

In repeated iterations of steps 404-414, the secondary admin selects, sets, and locks the “maximum transaction amount,” the geographic location requirement, and the time requirement fields. For example, the maximum transaction amount may be set to $500, the geographic location may be set to a state (e.g., Texas as defined by global positioning satellite (GPS) or other location information), and the time may be set to weekdays from 8:00 AM-5:00 PM. This indicates that the application 108 can only accept transactions of less than $500 that occur in the state of Texas between the hours of 8:00 AM-5:00 PM on weekdays. After the three fields are set and locked, the determination of step 414 determines that no other field is selected and the language display selector remains unlocked. The method 400 continues to step 416, where parameter(s) and/or screen(s) may be updated to reflect any changes made.

Returning to step 402, another login occurs using authentication information for the bottom level user (e.g., a user of the mobile device 102), who has the ability to view and modify all parameters not previously locked by higher levels. For purposes of illustration, the entries for “swipe required,” “maximum transaction amount,” the geographic location requirement, and the time requirement are set and locked, and the language display selector is unlocked. Referring again to FIG. 5, the bottom level 120M is illustrated with the single unlocked field. It is understood that the locked fields may be shown but cannot be modified by the bottom level user.

In steps 404-412, the bottom level user selects and sets the language display selector. For example, the selections may offer English and Spanish as options and the user may select English. It is understood that the bottom level may lock a field, but this may simply be selecting a field since any other user level can override the bottom level. Accordingly, steps 410 and 412 may not appear as options for the bottom level user in some embodiments. After the selection is made, the determination of step 414 determines that no other field is selected and the method 400 continues to step 416, where parameter(s) and/or screen(s) may be updated to reflect any changes made.

Referring again to the message sequence 200 of FIG. 2, after the application parameters are established in step 202, the application 108 is ready to be used. In step 204, the application 108 is launched on the device 102. At this point, the application 108 may be used in stand-alone mode if such a mode is available. In some embodiments, the application 108 may operate in stand-alone mode and then shut down without accessing the ACP 106. However, in the present example, in step 206, the application 106 performs an authentication process with the ACP 106 that identifies the application 108 to the ACP 106.

In step 208, after authentication, the ACP 106 identifies the parameters 116a that correspond to the application 108 and, in step 210, returns the parameters to the application 108. For example, the ACP 106 may send some or all of the parameters 116a and the application 108 may store them as parameters 110. In other embodiments, the parameters 116a may be sent only if changes have occurred since the previous login by the application 108. In step 212, the application 108 may be executed using the parameters 116a. Step 214 represents data and instructions that may pass between the device 102/application 108 and the ACP 106. It is understood that step 214 may appear between any of the illustrated steps and may also occur concurrently with illustrated steps.

In step 216, the application 108 receives input that includes a need to access a backend process, such as one of the backend processes 122-130 of FIG. 1. For example, the input may represent a financial transaction that needs access to the payment gateway 122 or may represent a change in a light system controlled via the lifestyle communications controller 128. In step 218, the application 108 sends the information to the ACP 106, which in turn contacts the appropriate backend process 122-130. In step 222, the application 108 and the backend process may communicate via the ACP 106.

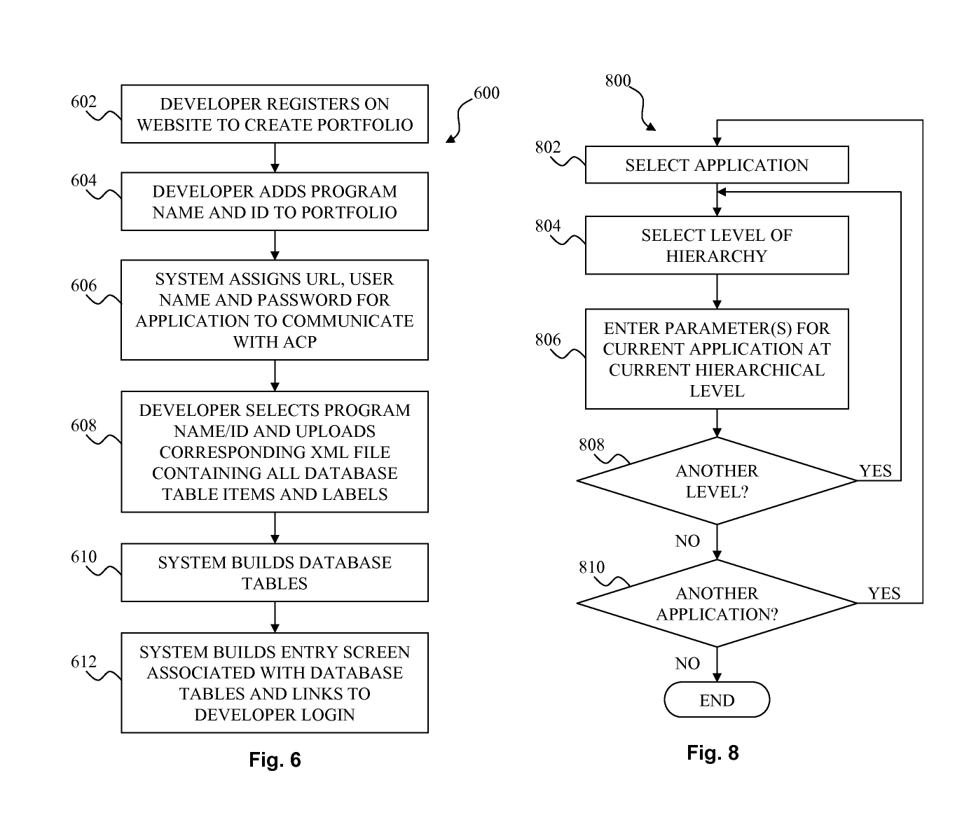

Referring to FIG. 6, a method 600 illustrates one embodiment of a process by which a developer may upload a program such as the application 108 for control by the ACP 106, which is managed by a third-party service provider. In the present example, the third-party service provider has a server that provides a website for uploading and managing applications such as the application 108. Other users may download the application 108 from the third-party service provider, either free or for a fee, as determined by the developer and the third-party service provider. The developer may modify the behavior of the application 108 via the admin system 118, which may be accessible through the website or by other means.

In step 602, the developer registers with the website to create a portfolio. In the present example, the portfolio is a directory or other file structure that relates the developer's applications with the developer so the developer does not need to individually register with the website for each new application. The portfolio is created and made available to the developer via, for example, an address such as a URL.

In step 604, the developer adds a program name and, in some embodiments, a program ID to the portfolio to indicate that the developer is preparing to upload or is in the process of uploading the application 108. For example, the developer may add the program name and then upload the application 108 or may upload the application 108 and add the program name when prompted by the system. In step 606, the system assigns an address such as a URL to the application 108 along with a user name and password needed by the application 108 to communicate with the ACP 106. It is understood that the user name and/or password may also be selected by the developer.

In step 608, the developer selects the program name and/or ID and uploads one or more files that define the desired parameters for the application 108. The file may be any type of file, but is an XML file for purposes of illustration. The XML file contains the database table items and labels needed for the ACP 106 to properly configure the application 108. The XML file may include information denoting which of the database items and labels are to be available to the admin system 118, which are to be hidden/locked, and similar information.

In step 610, the system builds the database tables based on the uploaded XML file(s). There may be separate database files, such as one table for application settings and one or more other tables for data storage. Accordingly, the actual number, format, and configuration of the database files may vary based on the particular implementation of the system.

In step 610, the system builds one or more entry screens based on the database tables and links the entry screen to the developer's login. The entry screen may provide the developer with access to the admin system 118 for configuration of the application 108. The entry screen may also provide access to statistics for the application 108, such as number of downloads, how many users are coupling their respective application to a background process, and similar information.

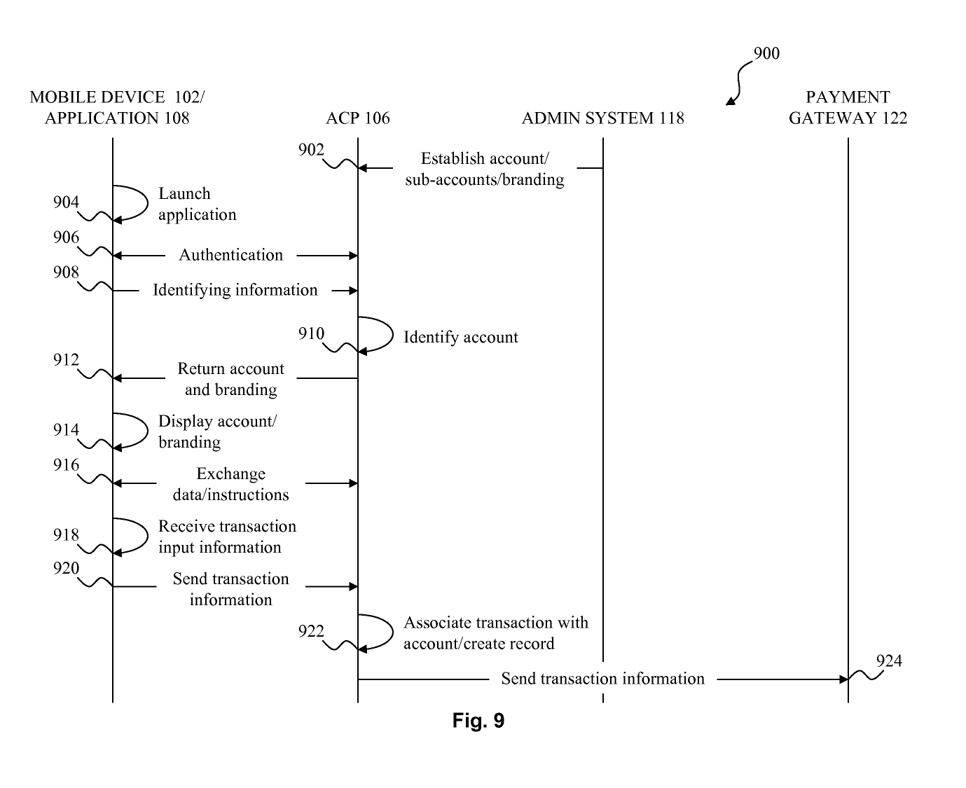

Referring to FIG. 9, a sequence diagram illustrates one embodiment of a message sequence 900 that may occur in the environment of FIG. 1 to dynamically configure authorization parameters for the devices 102/104 and/or applications 108/112. In the present example, the applications 108 and 112 are the same application installed on the two devices 102 and 104. The admin system 118 is used to set different hierarchical levels that may be applied to the application based on criteria such as a particular device on which the application is installed.

Accordingly, in step 702, via the admin system 118, a user may establish authorization parameters in a hierarchical manner. For example, assume the device 102 is assigned to level 1 of a hierarchy and the device 104 is assigned to level 2 of the same hierarchy. The user may then define the authorization parameters by assigning level 1 devices a particular level of access rights and assigning level 2 devices another level of access rights. The hierarchy may be defined to provide authorization based on one or more device identifiers (e.g., by phone number and/or by an Electronic Serial Number (ESN), International Mobile Equipment Identity (IMEI) number, or Mobile Equipment Identifier (MEID)) and/or by one or more application identifiers (e.g., username). In other embodiments, the authorization parameter(s) may be based on or modified using a device-specific implementation that enables parameters for a specific device to be modified individually.

The hierarchy may also be defined to change authorization rights based on factors such as geographic location and time. For example, increased access may be provided while an employee is at work and then more limited access may be provided when the employee is not at work. This enables authorization behavior to be changed on the ACP 106 rather than requiring changes to a particular device. In addition, such behavior may affect only the applications 108/112 on the devices, and not other applications. Accordingly, a user of the device 102 may have full access to all functionality of the device 102 with the exception of the application 108, which may be controlled via the hierarchical structure established in step 702.

In step 704, the application 108 authenticates with the ACP 106. In step 706, the ACP 106 retrieves the application parameter(s) for level 1 for the application 108 and, in step 708, sends the application parameter(s) to the application 108. Step 708 may include sending the actual parameters to the application 108 or may involve sending information as authorized by the parameters. For example, in one embodiment, the ACP 106 may send the parameters, which are then used by the application 108 to filter out particular functions and not present them to the user. In another embodiment, the ACP 106 may provide only limited information (e.g., only certain functionality) based on the parameters, without actually sending the parameters themselves to the application 108. Accordingly, it is understood that there may be variations in how the authorization hierarchy is actually implemented. In step 710, the application 108 functions as restricted or allowed by the parameters for level 1.

In step 712, the application 112 authenticates with the ACP 106. In step 714, the ACP 106 retrieves the application parameter(s) for level 2 for the application 112 and, in step 716, sends the application parameter(s) to the application 112. As with step 708, step 716 may include sending the actual parameters to the application 108 or may involve sending information as authorized by the parameters. In step 718, the application 112 functions as restricted or allowed by the parameters for level 2.

Accordingly, an application-specific access hierarchy may be established and enforced via the ACP 106 for applications that log into the ACP 106, even when the ACP 106 has no control over other applications on the devices 102 and 104. This enables a maximum level of control to be maintained via the ACP 106 when no other control is possible over the devices 102 and 104. As the control is application specific, configuration parameters may be changes as desired without affecting the devices themselves. It is understood that this control may be exerted on the applications 108 and 112 in stand-alone mode if the ACP 106 is able to change the respective local parameters 110 and 114. If the local parameters 110 and 114 cannot be changed by the ACP 106 (e.g., if the devices 102 and 104 do not permit local changes to occur), the ACP 106 may be limited to controlling functionality provided during online operation when the applications 108 and 112 are logged into the ACP 106.

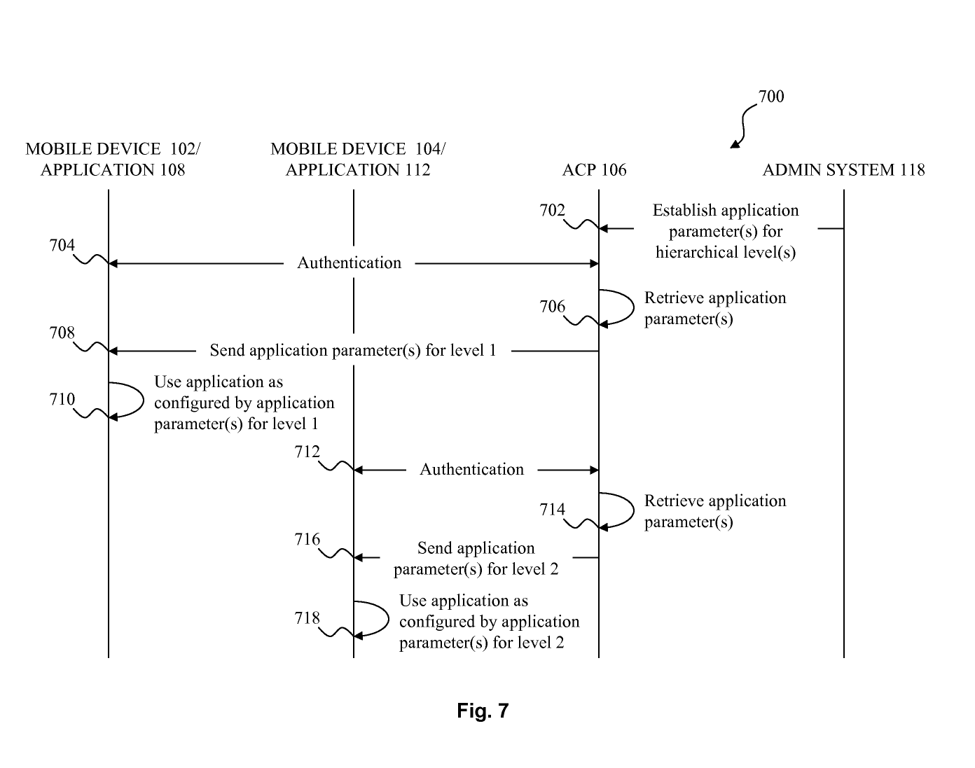

Referring to FIG. 8, in another embodiment, a method 800 illustrates a process by which a user may, via the ACP 106, establish control parameters for a specific application in a multiple hierarchy structure such as is described with respect to FIG. 7. For example, the method 800 may represent a more detailed embodiment of step 702 of FIG. 7.

In step 802, a user selects an application (e.g., the application 108/112) on the ACP 106 via the admin system 118. In step 804, the user selects a level of the hierarchy on the ACP 106 for which the application parameters are to be defined. In step 806, the user defines the parameters for the currently selected application at the currently selected hierarchical level. Although not shown, device specific parameters may also be included. The user may also define whether or not a parameter can be configured on the device-side to change the application or whether the parameter is locked and not modifiable except via the ACP 106.

In step 808, a determination may be made as to whether parameters for the currently selected application are to be defined for another level of the hierarchy. If another set is to be defined, the method 800 returns to step 804, where the user can select another level of the hierarchy. If no more parameters are to be defined for the currently selected application, the method 800 moves to step 810. In step 810, a determination may be made as to whether another application is to be selected. If not, the method 800 ends. If another application is to be selected, the method 800 returns to step 802.

Referring to FIG. 9, a sequence diagram illustrates one embodiment of a message sequence 900 that may occur in the environment of FIG. 1 to dynamically configure the application 108 on the device 102 of FIG. 1 via the ACP 106 with certain information. In the present example, the device 102 is a mobile device and the application 108 may be configured to display different visual information on a display of the device 102 based on information sent to and received from the ACP 106. The visual information may also impact backend processing via the ACP 106. In addition, the ACP 106 is coupled to a processor (e.g., a credit card processor) via the payment gateway 122 for financial transactions.

For purposes of illustration, a representative of an organization wants to display information to a client using the device 102. The information may be for display only or may be interactive and some or all of the information is provided by the ACP 106 to the device 102. Rather than being a single representation of data, it is desirable for the representative to select an account from multiple available accounts and for the ACP 106 to provide information that is tailored to the selected account.

As a more specific example, assume the organization is a business that has multiple locations in a city. A location may be a fixed address (e.g., a storefront) or may be a temporary location such as a conference or an event. Each location has its own physical address or other location identifier and is responsible for collecting and accounting for money that enters the organization through that location. For example, the organization may be a service provider or a merchandiser and each location may be an office in which clients or customers may meet with employees of the organization. In such cases, the representative may be a salesperson or another employee that works at more than one office in order to enable the firm to adjust to varying workloads and to fill in for employees who are sick or on vacation. In certain organizations, an employee may even meet a client at a non-office location, such as the client's business, a restaurant, or at a conference event. Accordingly, the particular needs of the organization may vary and it may be desirable to provide a unified account presentation format that includes multiple accounts that can be selected for viewing by a client as well as backend processing that is tied to the selected account.

In the present example, the organization has an account with an Independent Sales Organization (ISO) operating the ACP 106. The account includes general account information, such as the name and address of the organization and similar information. The account may be associated with default branding, such as a logo and the address of the headquarters or the main location of the organization (e.g., the anchor store), as well a color scheme or a style sheet. However, when the representative travels to another location, it may be desirable to have the branding reflect the current location rather than the default location, as this may reinforce local marketing efforts and may give a client more confidence in the organization and the representative. It may also be desirable to tie the business performed by the representative (e.g., receiving income for a sale) to a location in order to better track funds received within that location's assigned area.

Businesses having traveling sales or service personnel may find particular use in such a multi-account system. Other organizations, such as political organizations or other organizations that raise funds, may also find such a system useful as it enables an account to be tied to a specific client/purchaser/donator, a specific representative, and/or a specific location/event in a configurable manner. As such, even temporary events can be easily handled using a unique account that is configured on the ACP 106 and delivered to the device 102 in an easily selectable manner.

Accordingly, in step 902, the organization sets up multiple sub-accounts with the ISO on the ACP 106 via the admin system 118. Each sub-account may have its own branding and so may be associated with its own logo, address, and similar information (e.g., information such as discounts, specials, coupons, lists of representatives, store hours, and contact information). The sub-accounts may be related to the main account at the ISO or may be individual independent accounts that are otherwise related. For example, the accounts may be related in a field of the main account that lists related accounts. Accordingly, the term sub-accounts is used herein for purposes of convenience to denote related accounts and does not necessarily indicate an actual account hierarchy unless so specified.

The main account and/or sub-accounts may have the same authentication information (e.g., username and password) or may have different authentication criteria. For example, the application 108 may be authorized to access the main account, which may include all sub-accounts, or may be authorized to access only some sub-accounts. The application 112 may have the same or different authorizations as the application 108. The authentication information may also include such information as the device's telephone number and/or ESN, IMEI number, or MEID in order to authorize a specific device, rather than simply the application residing on a device. Such device information may also be used by the ACP 106 to identify the application.

With the sub-accounts active, the representative may visit a client at any location. In step 904, the representative opens the application 108. At this point, the application 108 may be used in stand-alone mode. For example, the representative may show a client information about the company, possible options for a purchase, or other information that may be stored on the device 102. However, maintaining a stand-alone application that is always up-to-date on its stored information lacks the flexibility of providing up-to-date on-demand information from the ACP 106.

Accordingly, the representative may want to access information available from the ACP 106 and, in step 906, selects an option that begins an authentication process between the application 108 and the ACP 106. In step 908, after authentication, the application 108 sends identifying information to the ACP 106, which is used by the ACP 106 in step 910 to identify a specific sub-account. The identifying information includes information that enables the ACP 106 to select the appropriate account/sub-account for use with the current application session on the device 102. For example, the identifying information may include a specific account identifier and/or location information of the device 102. Some identifying information may represent only the user's selection (e.g., send the sub-account corresponding to sub-account_ID), while other identifying information may automate the selection process (e.g., the location information may be used to identify the sub-account that best fits the location of the device 102). Still other options may provide for some user control while also automatically filtering the available options, such as using the location to provide a sub-set of available sub-accounts and letting the user select a sub-account from that sub-set.

In step 912, the ACP 106 returns the sub-account with its corresponding branding information. In step 914, the application 108 displays the account and branding information via a display of the device 102. Step 916 represents data and instructions that may pass between the device 102/application 108 and the ACP 106. It is understood that step 916 may appear between any of the illustrated steps and may also occur concurrently with illustrated steps.

In step 918, the application 108 receives input from the representative using the device 102. In the present example, the input represents financial transaction information (e.g., information from a credit card swipe), but the input may represent any type of transaction information (e.g., an order or a reservation). In step 920, the application 108 sends the transaction information to the ACP 106. Although not shown, the transaction information may be encrypted prior to being sent.

In step 922, the ACP 106 associates the received transaction information with the appropriate sub-account and, in some embodiments, may create a record of the transaction. For example, the ACP 106 may enter the transaction amount as a ledger entry under the sub-account. In step 924, the ACP 106 sends at least a portion of the transaction information to the processor via the payment gateway 122 for processing and client billing (e.g., for a credit card payment or a debit transaction).

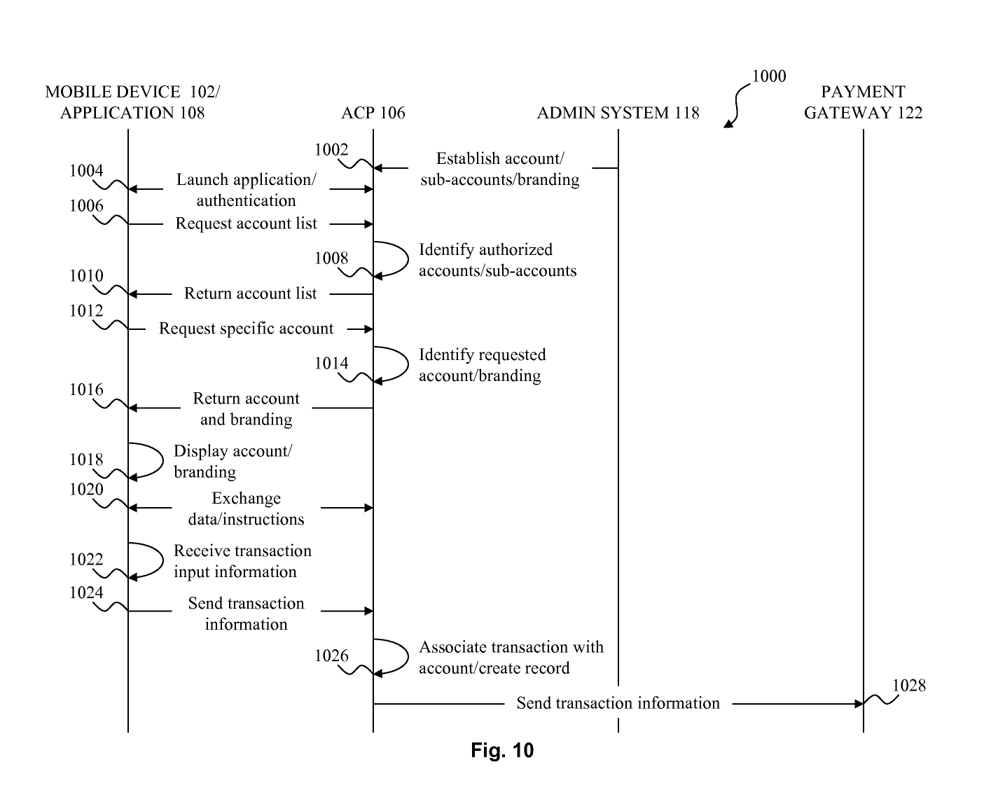

Referring to FIG. 10, a sequence diagram illustrates one embodiment of a message sequence 1000 that may occur in the environment of FIG. 1. The message sequence 1000 may be similar or identical to the message sequence 900 of FIG. 9 with the addition of steps where a user selects a specific account. For example, steps 1006-1014 may replace or illustrate a more specific embodiment of steps 908 and 910 of FIG. 9.

Steps 1002 and 1004 may be similar or identical to steps 902 and 904 of FIG. 9. For example, in step 1002, accounts, sub-accounts, and branding may be established as previously described. In step 1004, authentication may be performed between the device 102/application 108 and the ACP 106.

In step 1006, the application 108 sends a request to the ACP 106 for a list of accounts that are available to the application 108. As previously described, the limitations may be controlled in a number of ways, including use of the ESN, IMEI number, or MEID of the device 102. The requested list may be for a specific account or for multiple accounts (e.g., all available accounts). For example, the application 108 on the device 102 may be authorized to access multiple main accounts, and the request may be for a list of those main accounts. Alternatively, the request may be for a list of accounts related to a specific main-account.

In step 1008, the ACP 106 identifies the authorized account(s) and/or sub-account(s) corresponding to the request received in step 1006. In step 1010, the ACP 106 returns the account list to the application 108. In step 1012, the application 108 requests a specific sub-account. For example, the user of the device 102 may select one of the sub-accounts from the list received from the ACP 106 in step 1010, and the user's selection may trigger the request of step 1012. In step 1014, the ACP 106 identifies the requested account and its corresponding branding and, in step 1016, sends the account information and branding to the application 108.

In step 1018, the application 108 displays the account and branding information via a display of the device 102. Step 1020 represents data and instructions that may pass between the device 102/application 108 and the ACP 106. It is understood that step 1020 may appear between any of the illustrated steps and may also occur concurrently with illustrated steps.

In step 1022, the application 108 receives input from the representative using the device 102. In the present example, the input represents financial transaction information (e.g., information from a credit card swipe), but the input may represent any type of transaction information (e.g., an order or a reservation). In step 1024, the application 108 sends the transaction information to the ACP 106. Although not shown, the transaction information may be encrypted prior to being sent.

In step 1026, the ACP 106 associates the received transaction information with the appropriate sub-account and, in some embodiments, may create a record of the transaction. For example, the ACP 106 may enter the transaction amount as a ledger entry under the sub-account. In step 1028, the ACP 106 sends at least a portion of the transaction information to the processor via the payment gateway 122 for processing and client billing (e.g., for a credit card payment or a debit transaction).

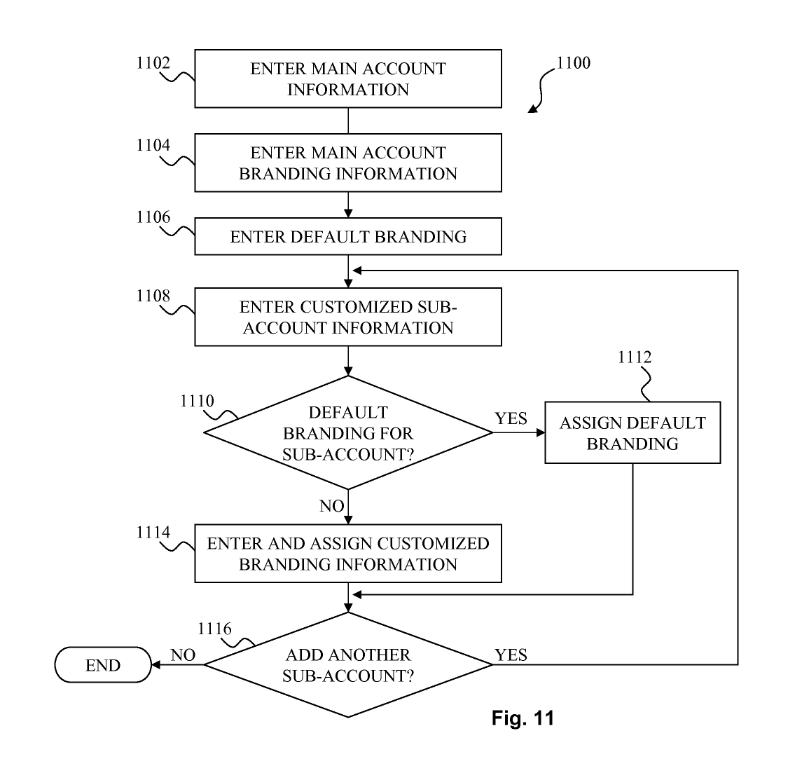

Referring to FIG. 11, in another embodiment, a method 1100 illustrates a process by which the ACP 106 may be configured with multiple accounts that can be readily accessed by the application 108 on the device 102. In step 1102, information is entered for a main account. This establishes the main account on the ACP 106. For example, in the case of an organization, the main account information may include the contact information, banking information, and similar information needed for the ACP 106 to operate. If one or more processors are involved, the processors may be linked to the main account via merchant identification (ID) numbers or other identifiers that enable the organization to pass financial transactions to the processors via the payment gateway 122.

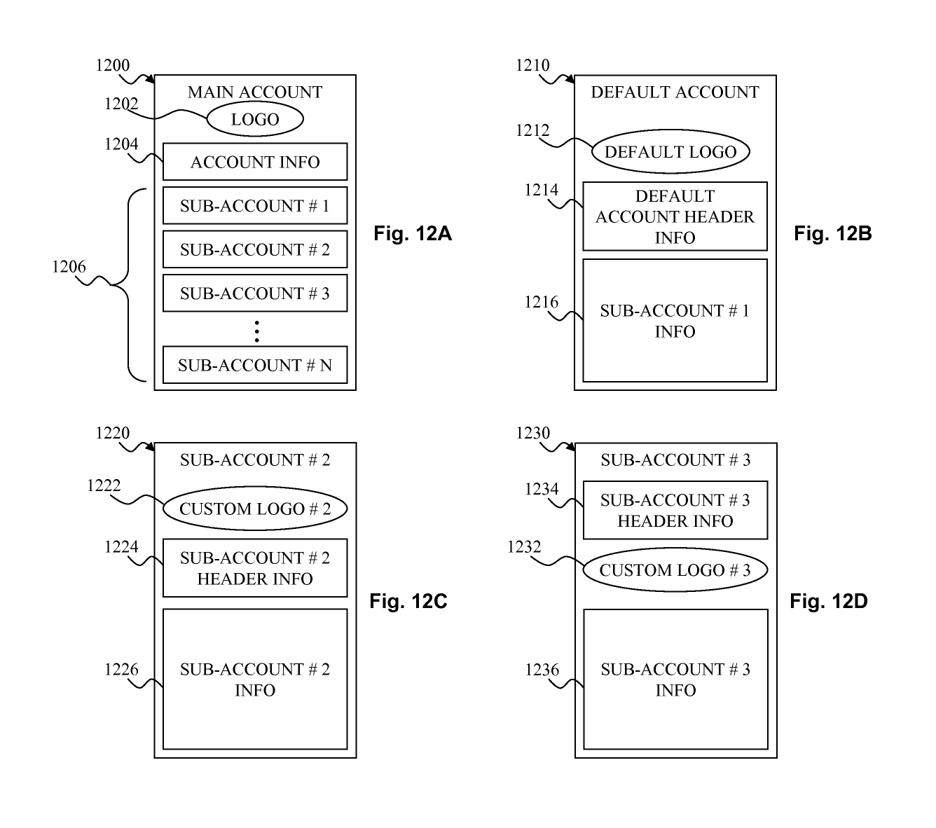

In step 1104 and with additional reference to FIG. 12A, branding information for the main account may be entered. As illustrated in FIG. 12A, a display 1200 of the device 102 shows the main account information with branding. For example, the branding may include a logo 1202, a color/template scheme, page layout, and similar information. The main account information may include account information 1204 that details information pertinent to the main account (e.g., address and contact person). The main account information may also include various sub-account listings, illustrated in FIG. 12A as sub-accounts #1, #2, #3, . . . , #N. It is understood that the display may scroll or otherwise provide other processes to view additional information if there is more information than can be shown on a single screen. In step 1106, default branding may be entered for sub-accounts as will be discussed in a following step.

In step 1108, customized sub-account information may be entered. For example, the main account may have just been created and sub-accounts may need to be added, or an additional sub-account may be added to an existing main account at a later time. As more specific illustrations, the sub-accounts #1, #2, #3, . . . , #N may be different locations for an organization or may be different events attended by a representative, such as conventions, conferences, or political fund raisers. For purposes of example, the present sub-account information is for sub-account #1. The sub-account information may include financial transaction information, such as a merchant ID and/or other information that may be needed for credit/debit card transactions for the processor.

In step 1110, a determination may be made as to whether sub-account #1 is to receive the default branding scheme established in step 1106 or a customized branding scheme. In the present example, sub-account #1 is to receive the default branding, and so the method 1100 continues to step 1112. In step 1112 and with additional reference to FIG. 12B, the default branding is applied to sub-account #1. As illustrated in FIG. 12B, a display 1210 of the device 102 shows the default branding for a sub-account. For example, the branding may include a logo 1212, a color/template scheme, page layout including a sub-account header 1214, and similar information. The default information may include sub-account information 1216 that details information pertinent to the sub-account #1.

After the default branding scheme is assigned to sub-account #1 in step 1112, the method 1100 continues to step 1116 (skipping step 1114). In step 1116, a determination may be made as to whether another sub-account is to be added. If not, the method 1100 ends. If another sub-account is to be added, the method 1100 returns to step 1108. In the present example, an additional sub-account is to be added, so the method 1100 returns to step 1108.

In step 1108, customized sub-account information may be entered for sub-account #2. In step 1110, a determination may be made as to whether sub-account #2 is to receive the default branding scheme established in step 1106 or a customized branding scheme. In the present example, sub-account #2 is to receive a customized branding scheme, and so the method 1100 continues to step 1114. In step 1114 and with additional reference to FIG. 12C, the customized branding for sub-account #2 is entered and applied to sub-account #2. As illustrated in FIG. 12C, a display 1220 of the device 102 shows the branding for sub-account #2. For example, the branding may include a custom logo 1222, a color/template scheme, page layout including a sub-account header 1224, and similar information. The information may include sub-account information 1226 that details information pertinent to the sub-account #2.

After the customized branding scheme is assigned to sub-account #2 in step 1114, the method 1100 continues to step 1116 (skipping step 1112). In step 1116, a determination may be made as to whether another sub-account is to be added. If not, the method 1100 ends. If another sub-account is to be added, the method 1100 returns to step 1108. In the present example, an additional sub-account is to be added, so the method 1100 returns to step 1108.

In step 1108, customized sub-account information may be entered for sub-account #3. In step 1110, a determination may be made as to whether sub-account #3 is to receive the default branding scheme established in step 1106 or a customized branding scheme. In the present example, sub-account #3 is to receive a customized branding scheme, and so the method 1100 continues to step 1114. In step 1114 and with additional reference to FIG. 12D, the customized branding for sub-account #3 is entered and applied to sub-account #3. As illustrated in FIG. 12D, a display 1230 of the device 102 shows the branding for sub-account #3. For example, the branding may include a custom logo 1232, a color/template scheme, page layout including a sub-account header 1234, and similar information. The information may include sub-account information 1236 that details information pertinent to the sub-account #3. As illustrated in FIGS. 12C and 12D, the layout of branding may differ across sub-accounts.

Accordingly, using the admin system 118, various sub-accounts may be defined on the ACP 106 as desired. These sub-accounts may be modified so that the applications 108 and 112 pull up the most current version of a particular sub-account. Although not shown, it is understood that sub-account authorizations may also be performed in the method 1100 to define what applications/devices are able to access a certain sub-account.

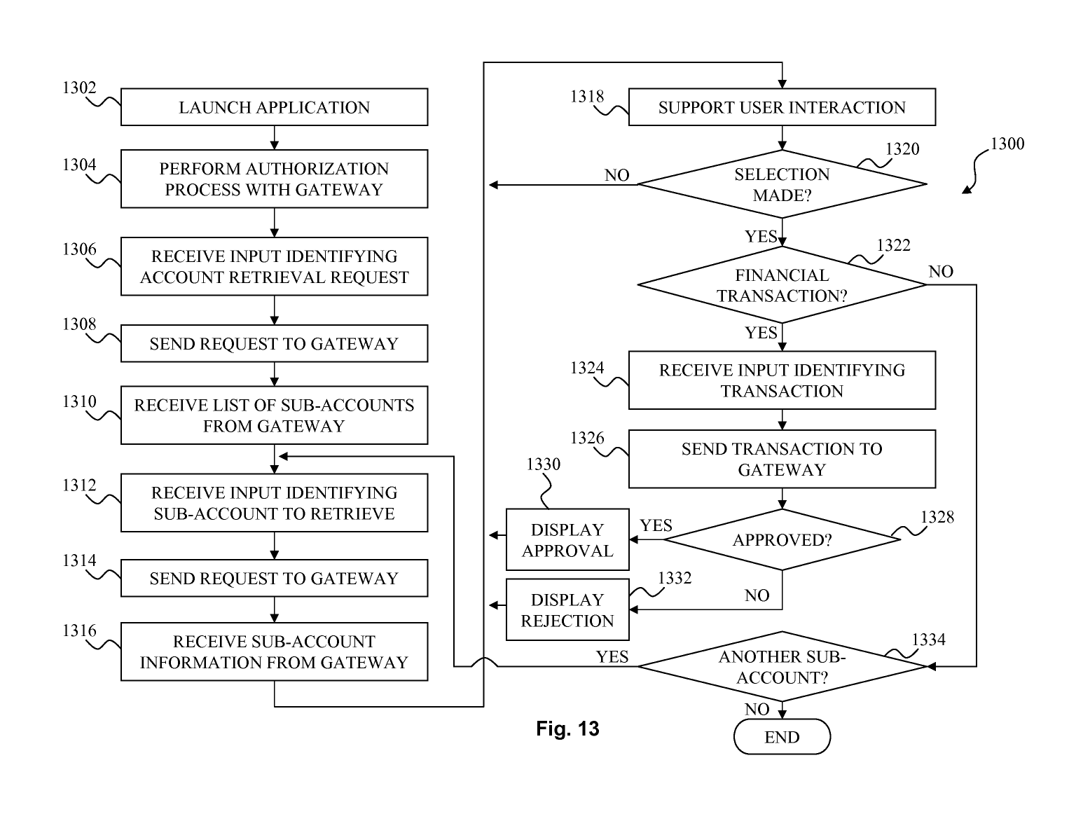

Referring to FIG. 13, in another embodiment, a method 1300 illustrates a process by which the device 102/application 108 may handle user input and communicate with the ACP 106. In the present example, the device 102 is a mobile device, but it is understood that it may be a wired device in other embodiments.

In step 1302, the application 108 is launched on the device 102. This may occur when the application 108 is selected by the user of the device 102 or when another defined event occurs, such as when the device 102 enters a particular geographical area or a designated time occurs. At this point, the application 108 may be in stand-alone mode in some embodiments, and so may present some functionality to the user even though the application 108 is not yet coupled to the ACP 106. In other embodiments, the application 108 may automatically perform certain background processes that connect to the ACP 106, such as checking for and downloading updates, even though the user has not yet officially logged into the ACP 106 to access desired functionality.

In step 1304, the application 108 performs an authorization process with the ACP 106. The authorization process may include data entry (e.g., username and password) by a user of the device 102 or may be automatic using information previously entered into the application 108 and/or identifying information from the device 102 (e.g., phone number, ESN, IMEI number, or MEID). At this time, the application 108 is no longer in stand-alone mode (assuming the application 108 is configured for such a mode) and is coupled to the ACP 106.

In step 1306, the application 108 receives input representing a user's desire to retrieve account information. The input may identify a specific account or may simply request all available accounts. In step 1308, the request is passed to the ACP 106 and, in step 1310, a list of accounts is received from the ACP 106. In step 1312, input is received identifying a specific account/sub-account to retrieve based on the list and the request is sent to the ACP 106 in step 1314. It is noted that this process corresponds to a portion of message sequence 300 of FIG. 3, where user input is used to identify and select an account, rather than the selection occurring automatically based on information such as geographical location. In step 1316, the sub-account information is received from the ACP 106.

At this point, as embodied in step 1318, the user may display the sub-account information (if desired), may move to other pages of the sub-account, and/or may perform other actions that entail interacting with the application 108 and the retrieved sub-account. In the present example, the method 1300 checks for particular user selection events (e.g., initiation of a financial transaction or selection of another sub-account) in step 1320. If no user selection event has occurred, the method 1300 returns to step 1318.

In the present example, the interaction includes a selection that signals a defined event. The event may be, for example, the user selecting a transaction type via the application 108 or swiping a credit/debit card. The selection is caught in step 1320 and the method 1300 continues to step 1322. In step 1322, a determination is made as to whether the event is a financial transaction. If the event is a financial transaction, the method 1300 continues to step 1324, where input is received. The input may correspond to a swipe of the card, the entry of a particular amount into the application 108, the entry of a signature into the application 108, and/or any other information needed to complete the transaction. In some embodiments, the input of step 1324 may have served as the event trigger of step 1320 or the financial transaction identifier of step 1322, in which case various steps may be combined. In step 1326, the transaction is then sent to the ACP 106.

In step 1328, a determination may be made as to whether the financial transaction is approved by the ACP 106. For example, the financial transaction may be compared to a predefined limit for the application 108 and/or mobile device 102 on the ACP 106. A message or other indicator may be received from the ACP 106 for the determination of step 1328. If the financial transaction is approved, the method 1300 moves to step 1330, where an approval is displayed. If the financial transaction is rejected, the method 1300 moves to step 1332, where a rejection is displayed. It is understood that the approval/rejection may be displayed in many different ways and need not be an explicit visual display indicating the approval/rejection. After step 1330 or 1332, the method 1300 may return to step 1318 for further user interaction.

If the event is not a financial transaction as determined in step 1322, the method 1300 moves to step 1334. In step 1334, a determination may be made as to whether the event was the selection of another sub-account. If not, the method 1300 may treat the event as an end event (as shown) or may handle the event as otherwise defined (e.g., may return to step 1318). If the event was a sub-account selection, the method 1300 moves to step 1312 where input identifying the specific sub-account to retrieve is identified. In other embodiments, the event itself may identify the sub-account, in which case the method 1300 may return to step 1314 and send the request.

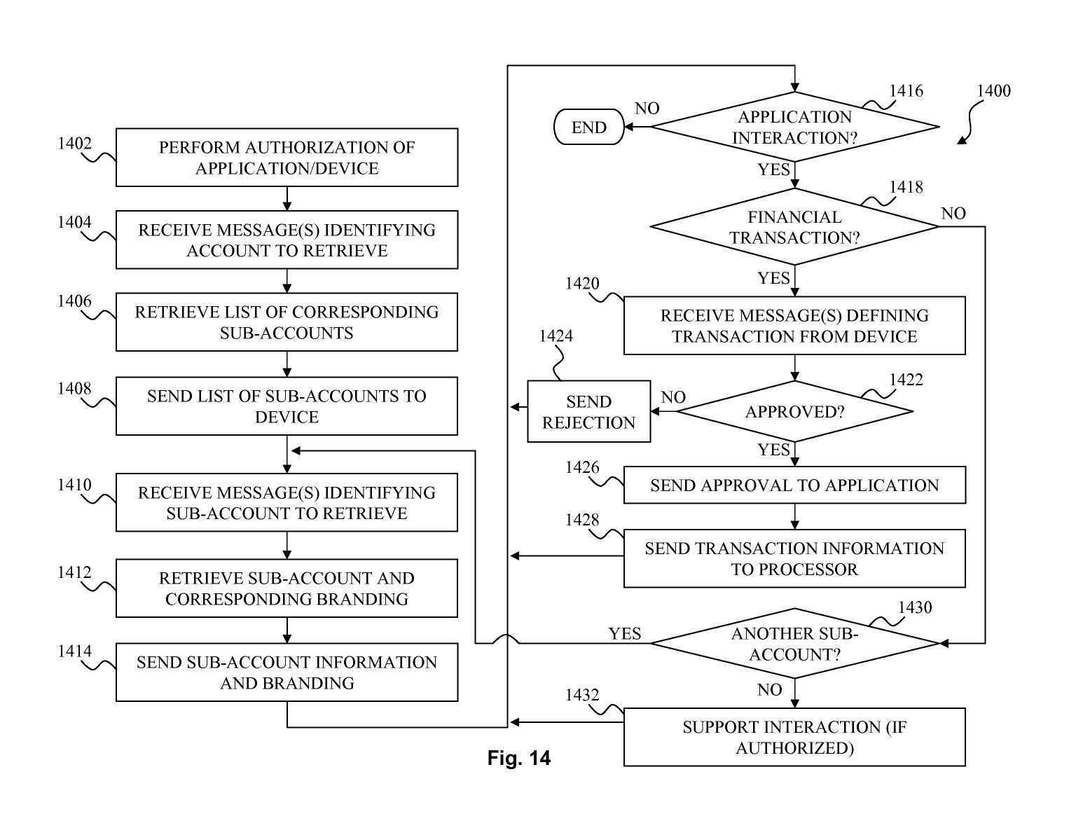

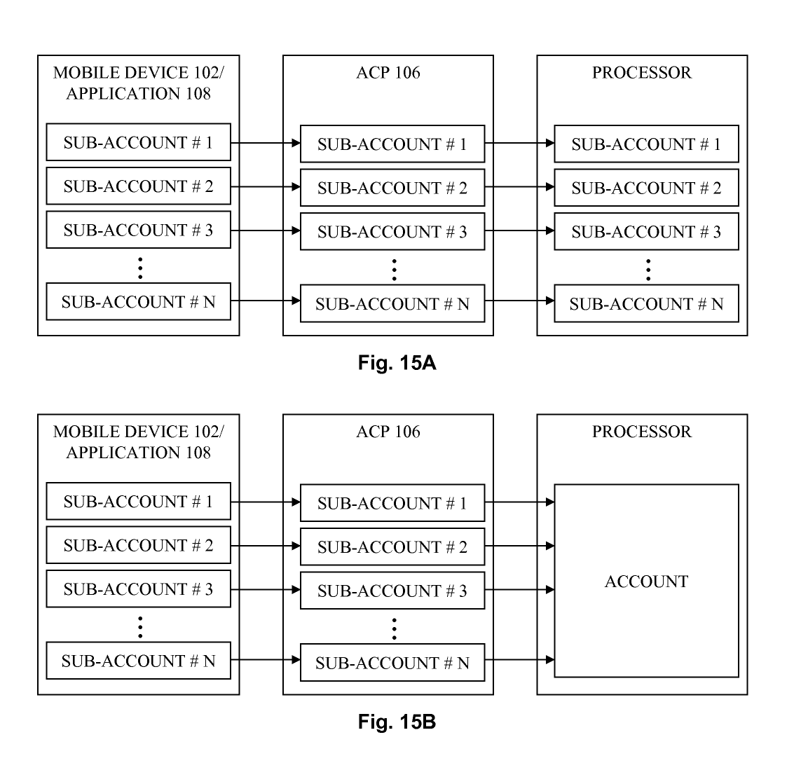

Referring to FIG. 14, in another embodiment, a method 1400 illustrates a process by which the ACP 106 may communicate with the device 102/application 108 and process requests/instructions. In the present example, the device 102 is a mobile device, but it is understood that it may be a wired device in other embodiments.

In step 1402, the ACP 106 receives an authorization request from the device 102 and/or application 108. The contents of the authorization request may depend on many different factors, such as whether the application 108 is able to authenticate without additional information from the device 102 or whether such device information is needed. The authorization request or a later message may also include additional information such as location information, and the additional information may be used to determine what information can be accessed by the application 108.

In step 1404, the ACP 106 receives one or more messages from the application 108/device 102 identifying a main account. In some embodiments, step 1404 may involve requesting, by the application 108, a list of accounts and/or sub-accounts. In still other embodiments, the ACP 106 may send one or more accounts/sub-accounts to the application 108 based on previously received information, such as location information. In such embodiments, various steps of the method 1400 (e.g., steps 1404-1410) may be omitted or altered.

In step 1406, the ACP 106 retrieves the list of sub-accounts corresponding to the requested main account and, in step 1408, sends the list of sub-accounts to the application 108. In step 1410, the ACP 106 receives messages identifying a particular one of the sub-accounts and, in step 1412, retrieves the sub-account and the corresponding branding. In step 1414, the ACP 106 sends the sub-account and branding information to the application 108.

For example, assume the message received by the ACP 106 in step 1404 requests the main account illustrated in FIG. 12A. In steps 1406 and 1408, the ACP 106 would retrieve and return sub-accounts #1, 2, 3, . . . , N (or whatever sub-accounts are authorized). In step 1410, the ACP 106 may receive a message requesting sub-account #2 (as illustrated in FIG. 12C). The ACP 106 would retrieve sub-account 2 and the branding associated with the sub-account in step 1412 and send the information to the application in step 1414.

In step 1416, a determination may be made as to whether there is interaction with the application 108. For example, the ACP 106 may check to see if messages are being received from the application 108, whether a terminate instruction has been received, or whether a timeout has occurred. If there is no interaction or if a message indicating that no interaction is to occur has been received (e.g., a terminate instruction), the method 1400 may end. If there is interaction, the method 1400 moves to step 1418, where a determination may be made as to whether the interaction indicates a financial transaction. If it is a financial transaction, the method 1400 continues to step 1420, where one or more messages may be received defining the transaction. In some embodiments, one of the messages may be used in the determination of step 1418. The messages received in step 1420 may define credit/debit card information resulting from a swipe of the card or having the information keyed into the device 102, a particular amount, a signature, and/or any other information needed to complete the transaction.

In step 1422, a determination may be made as to whether the financial transaction is approved by the ACP 106. For example, the financial transaction may be compared to a predefined limit for the application 108 and/or mobile device 102 on the gateway 106. If the financial transaction is rejected as determined in step 1422, the method 1400 moves to step 1424, where a rejection is displayed. After step 1424, the method 1400 may return to step 1416 for further user interaction. If the financial transaction is approved, the method 1400 moves to step 1426, where an approval is displayed. It is understood that the approval/rejection may be displayed in many different ways and need not be an explicit visual display indicating the approval/rejection. In step 1428, the transaction is then sent to the processor via the payment gateway 122. After step 1428, the method 1400 may return to step 1416 for further user interaction.

If the interaction does not identify a financial transaction as determined in step 1418, the method 1400 moves to step 1430. In step 1430, a determination may be made as to whether the interaction identifies the selection of another sub-account. If the interaction is a sub-account selection, the method 1400 moves to step 1410 where one or more messages identifying the specific sub-account to retrieve are received. In other embodiments, the interaction itself may identify the sub-account, in which case the method 1400 may return to step 1412 and send the request. If another main account is requested, the method 1400 would move to step 1404.

If the determination of step 1430 identifies that the interaction is not a sub-account selection, the method 1400 moves to step 1432, where the interaction may be supported. Such support may depend on authorization, the configuration of the ACP 106 (e.g., if the ACP 106 and/or sub-account is configured to provide the requested interaction), and similar factors. The method 1400 then returns to step 1416. It is noted that interaction in step 1432 that is unauthorized or unsupported may result in the method 1400 returning to step 1416 and either ending or sending an error message to the application 108.

Referring to FIGS. 15A and 15B, two embodiments of account handling by the ACP 106 of FIG. 1 are illustrated. The ACP 106 may be configured to handle accounts and sub-accounts to meet different requirements. This provides flexibility for accounting and management purposes while not requiring changes to the interface displayed to users on the devices 102 and 104. As the ACP 106 may be reconfigured as desired via the admin system 118, changes to how an account is handled need not be propagated to the application 108 and 112 other than when information is requested for that account.

FIG. 15A illustrates an embodiment where the ACP 106 tracks financial transactions on a per account/sub-account basis. In other words, the ACP 106 is configured to separately track the financial transactions occurring for a particular account or sub-account. In this example, the ACP 106 then passes each transaction on to separate sub-accounts on the processor. For example, each sub-account may correspond to a unique identifier (e.g., a merchant ID) and the ACP 106 passes the financial transactions to the corresponding merchant ID on the processor via the payment gateway 122.

FIG. 15B illustrates an embodiment where the ACP 106 tracks financial transactions on a per account/sub-account basis, but passes them into a single account on the processor. In this example, after tracking the financial account information for a particular sub-account, the ACP 106 then passes each transaction into a single account on the processor regardless of sub-account. For example, each sub-account may correspond to the same unique identifier (e.g., a merchant ID) as the other sub-accounts, and the ACP 106 passes the financial transactions to the corresponding merchant ID on the processor via the payment gateway 122. In this example, the ACP 106 is able to provide detailed tracking statistic for each sub-account even though the sub-accounts are all tied to a single merchant ID on the processor.

It is understood that many variations may occur. For example, sub-accounts #1 and #2 may be tied to one account on the processor, while sub-accounts #3-#N may be tied to another sub-account. Accordingly, the ACP 106 provides a great deal of flexibility without requiring changes to the application 108.

This control by the ACP 106 may be used to regulate the behavior of the application 108 with respect to various transactions as well. For example, the ACP 106 has the ability to control the maximum dollar amount entered into the application 108. The maximum dollar amount may be used to control a single transaction, such as limiting a transaction to $500 or some other amount. The maximum dollar amount may be used to control a daily, monthly, or annual total transaction volume, or a volume based on some other specified time period (e.g., a quarter). The control can be for a particular application or user (e.g., the individual who controls the device 102) or for someone else, such as a customer of the user. So while the user may not be limited, the control may be applied to a particular customer.

The ACP 106 may also control a customer's total transaction volume by day, week, month, year, or another factor, such as an event. For example, an event may be a fundraiser. The customer's total transaction volume may include multiple devices and/or applications. For example, a customer may have an account tied to both the applications 108 and 112, so that the total volume is calculated based on transactions submitted to the ACP 106 by both applications.

An example of this type of control may be a political fundraiser. Suppose that two political events occur within a two week period for a particular candidate and that the maximum total contribution allowed for a single donor is $2500. At the first event, a representative using the device 102 uses the application 108 to select an account (e.g., either a general account for the candidate or an account set up for that event) and swipes the donor's credit card for $2000. The ACP 106 will log this transaction. At the second event, the donor's attempt to donate another $1000 to a representative who is using the device 104 and the application 112, although the device 102/application 108 may be used as well. The ACP 106 will note that the second contribution exceeds the maximum total contribution allowed for that donor and will deny the transaction. The denial may be general (e.g., “transaction denied”) or may be more specific (e.g., “a maximum of $500 may be donated” or “the current contribution is $500 over the allowable limit”). Accordingly, not only may the selection of a particular account be useful to track funds, but the ACP 106 may be used to control total contributions made via applications that access the ACP 106.

The control extended by the ACP 106 may be configured in many different ways. For example, when the device 102 is a mobile device, it may be limited in its ability to process transactions by the location of the device, thereby allowing or preventing transactions within a given area or location or outside a given area or location, such as a city, state, country, or some other geographical area. Time and other criteria may also be used, such as allowing transactions to occur only during defined business hours.

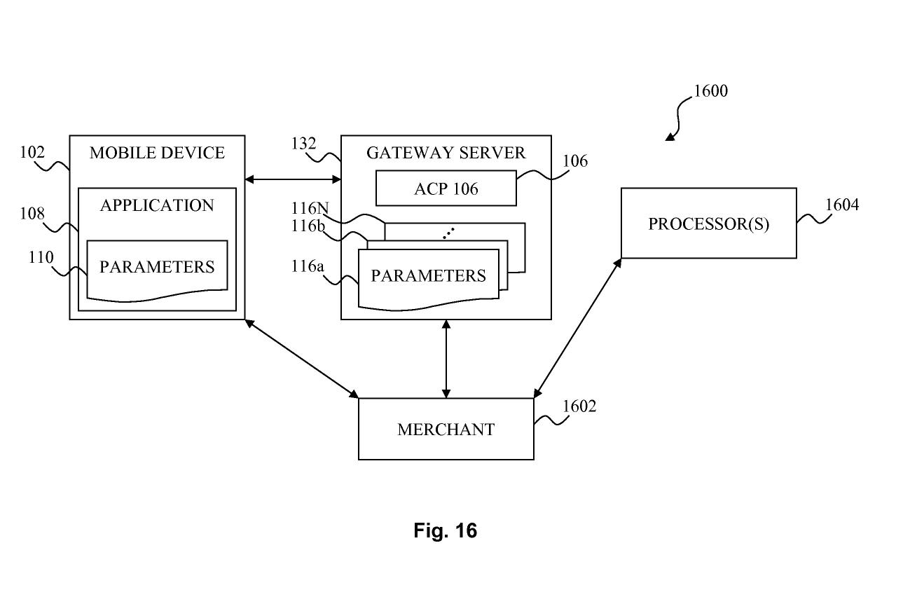

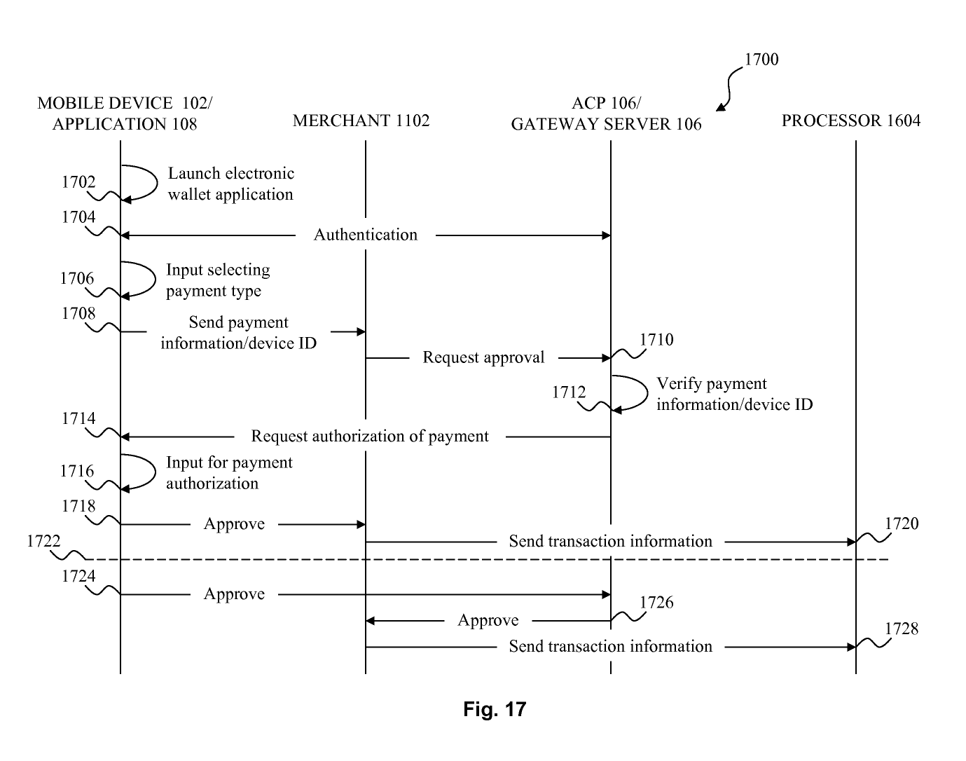

Referring to FIG. 16, in another embodiment, an environment 1600 is illustrated that is similar to the environment 100 of FIG. 1 with the addition of a merchant 1602. The merchant 1602 is able to receive and accept electronic payments from the device 102, which is a wireless device in the present example. For example, the merchant 1602 may include a wireless terminal that is able to communicate with the device 102. The application 108 represents a payment wallet application that may be used to store various forms of payment that may then be used to make secure electronic purchases. The merchant 1602 is also coupled to the ACP 106/gateway server 132 and processor(s) 1604. Interaction between the components in the environment 1600 is described below with respect to FIG. 17.

Referring to FIG. 17, a sequence diagram illustrates one embodiment of a message sequence 1700 that may occur in the environment 1600 of FIG. 16 to enable an electronic transaction to occur between the device 102 and the merchant 1602. The electronic transaction provides security for both the device 102 and the merchant 1602, and also provides for control by the gateway server 132 using previously described embodiments.

In the present example, a user of the device 102 (or another user if, for example, an organization), has previously stored payment information on the gateway server 132. For example, the payment information may include various credentials such as credit/debit card and bank account numbers, expiration dates, security codes, pin numbers, and similar information. Accordingly, when the user of the device 102 wants to make a payment to the merchant 1602, this information is already stored on the gateway server 132. The application 108 may store some or all of the information, such as a portion of the number or a user selected name for each available form of payment.

Accordingly, when the user launches the electronic wallet application in step 1702, the gateway server 132 includes the electronic wallet information. In step 1704, the application 108/device 102 authenticates with the gateway server 132 as previously described. In step 1706, the user of the application 108 selects a payment type from the wallet application (e.g., visa credit card or direct bank debit). This step may also include entering an amount and any other information needed to format the payment. The payment information may also include information such as bar code information, near-field communication (NFC) information, radio-frequency identification (RFID) information, or Smart Chip information for purposes such as security and/or identification. In step 1708, the application 108 sends the payment to the merchant 1602.

In step 1710, the merchant 1602 sends the payment information to the gateway server 132 to request approval for the payment. This step may be used to protect both the merchant 1602 and the user, as the gateway server 132 may reject the approval request if the payment information does not match the information on file for the device 102. The user may be protected because, in step 1712, the gateway server 132 sends a payment authorization request to the device 102/application 108. The request may require a pin number or some other predefined code to proceed with the payment, or simply requiring approval by the application 108 may be deemed sufficient. In step 1714, the user authorizes the payment. In step 1716, the authorization is sent to the merchant 1602 and, in step 1718, the merchant 1602 sends the payment information to the processor 1604 for approval and processing.

In an alternative embodiment, as shown below line 1720, the authorization sequence may be somewhat different. More specifically, in step 1722, the approval from the user may be sent to the gateway server 132 rather than to the merchant 1602. In step 1724, the gateway server 132 sends the approval to the merchant 1602, which then sends the payment information to the processor 1604 in step 1726. This alternative embodiment replaces step 1716 with steps 1722, 1724.

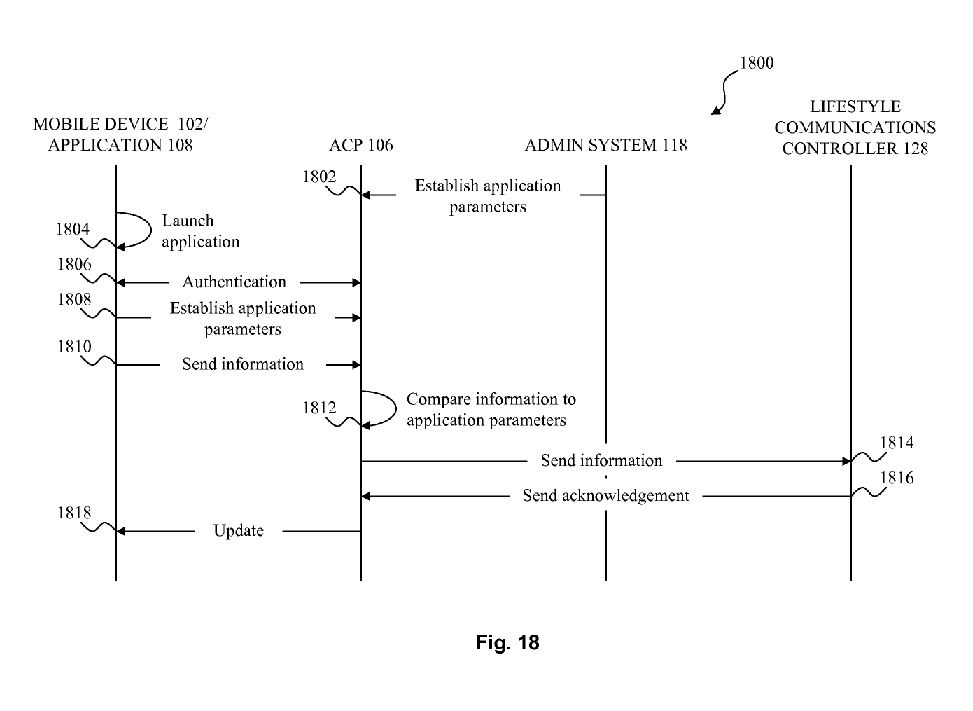

Referring to FIG. 18, a sequence diagram illustrates one embodiment of a message sequence 1800 that may occur in the environment 100 of FIG. 1 to enable the application 108 to communicate with a structure (e.g., a home) via the lifestyle communications controller 128. In the present example, the mobile device 102 is able to provide GPS information to the application 108, which enables the application 108 to send location information to the ACP 106.

In step 1802, a user or developer of the application 108 may use the admin system 118 to set various parameters for the application 108. For example, a user may set various home systems to be monitored and/or controlled, such as a lighting system and a HVAC system. The user may also provide subscription information for the lifestyle communications controller 128 or authentication information for the ACP 106 to use with the lifestyle communications controller 128 on behalf of the application 108. For purposes of illustration, the user may set such parameters as instructing the exterior lights to be turned on at 7:00 PM and instructing the air conditioning to drop to seventy-three degrees at 5:00 PM or whenever the user is within two miles of his house. In another example, a developer may set various limitations on the application 108 unless the user pays for additional functionality.

In step 1804, the application 108 is launched on the mobile device 102 and, in step 1806, authenticates with the ACP 106. In step 1808, the application 108 may establish application parameters with the ACP 106. For example, the user may change a previously made setting or may provide information not previously supplied to the ACP 108 via the admin system 118. Step 1808 may be omitted if no parameters are to be updated or set at the time. In step 1810, the application 108 sends information to the ACP 106. The information may be any information, but in the present example the information is the location information obtained via the device 102's GPS functionality.

Accordingly, in step 1812, the ACP 106 compares the location of the mobile device 102 to the established parameters. In the present case, the user is one mile from his home (e.g., within the two mile radius set in the parameters) and the ACP 106 sends a request to the lifestyle communications controller 128 to lower the air conditioning to seventy-three degrees. The request may be to lower the air conditioning or may simply be the location information of the mobile device if the lifestyle communications controller 128 is configured to recognize the location and act accordingly. In step 1816, the lifestyle communications controller 128 acknowledges the request by sending a response such as an acknowledgement to the ACP 106. In step 1818, the ACP 106 updates the application 108. Accordingly, by using the application 106 to send information to the lifestyle communications controller 128 via the ACP 106, the user can dynamically update the lifestyle communications controller 128.

In another embodiment, the application 108 may be used to provide an individual news feed from a particular news source where the application shows a summary of top news items from that source. The user may be able to change the news feed from one news source to another news source or set up multiple news feeds that are available from the backend processes.

In still another embodiment, the application 108 may be used to configure menu items or functionality of the mobile device 102 to change by time of day or GPS location. For example, a work address book may be presented during work hours and/or when the GPS location indicates that the user is at work and a personal address book may be presented during non-work hours and/or when the GPS location indicates that the user is at home. Accordingly, many different levels of customization may be provided by the ACP 106 in conjunction with the application 108.

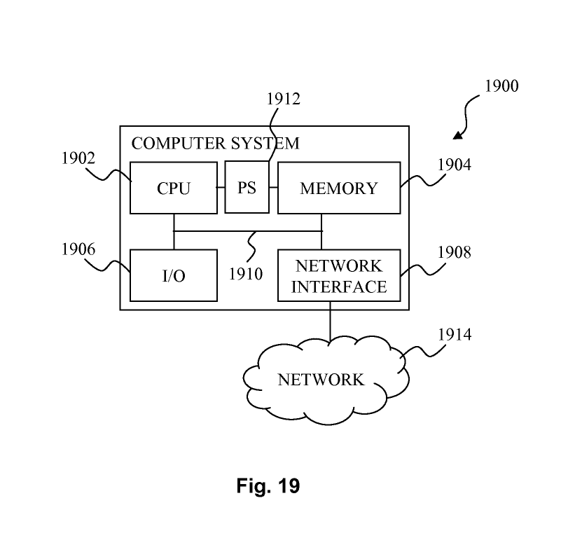

Referring to FIG. 19, one embodiment of a computer system 1900 is illustrated. The computer system 1900 is one possible example of a system component or computing device such as one of the mobile devices 102 or 104 or the gateway server 132 of FIG. 1. The computer system 1900 may include a controller (e.g., a central processing unit (“CPU”)) 1902, a memory unit 1904, an input/output (“I/O”) device 1906, and a network interface 1908. The components 1902, 1904, 1906, and 1908 are interconnected by a transport system (e.g., a bus) 1910. A power supply (PS) 1912 may provide power to components of the computer system 1900, such as the CPU 1902 and memory unit 1904. It is understood that the computer system 1900 may be differently configured and that each of the listed components may actually represent several different components. For example, the CPU 1902 may actually represent a multi-processor or a distributed processing system; the memory unit 1904 may include different levels of cache memory, main memory, hard disks, and remote storage locations; the I/O device 1906 may include monitors, keyboards, and the like; and the network interface 1908 may include one or more network cards providing one or more wired and/or wireless connections to a network 1914. Therefore, a wide range of flexibility is anticipated in the configuration of the computer system 1900.

The computer system 1900 may use any operating system (or multiple operating systems), including various versions of operating systems provided by Microsoft (such as WINDOWS), Apple (such as Mac OS X), UNIX, and LINUX, and may include operating systems specifically developed for handheld devices, personal computers, and servers depending on the use of the computer system 1900. The operating system, as well as other instructions (e.g., for an endpoint engine as described in a later embodiment if an endpoint), may be stored in the memory unit 1904 and executed by the processor 1902. For example, if the computer system 1900 is one of the mobile devices 102 or 104 or the network accessible platform 132, the memory unit 1904 may include instructions for performing some or all of the message sequences and methods described herein.

The network 1914 may be a single network or may represent multiple networks, including networks of different types. For example, the device 102 may be coupled to the device 104 via a network that includes a cellular link coupled to a data packet network, and the device 102 may be coupled to the network accessible platform 132 via a data packet link such as a wide local area network (WLAN) coupled to a data packet network or a Public Switched Telephone Network (PSTN). Accordingly, many different network types and configurations may be used to couple the devices 102 and 104 and the network accessible platform 132 to one another.

While the preceding description shows and describes one or more embodiments, it will be understood by those skilled in the art that various changes in form and detail may be made therein without departing from the spirit and scope of the present disclosure. For example, various steps illustrated within a particular sequence diagram or flow chart may be combined or further divided. In addition, steps described in one diagram or flow chart may be incorporated into another diagram or flow chart. Some steps may be performed in an order different from that shown and/or may overlap. Furthermore, the described functionality may be provided by hardware and/or software, and may be distributed or combined into a single platform. Additionally, functionality described in a particular example may be achieved in a manner different than that illustrated, but is still encompassed within the present disclosure. Therefore, the claims should be interpreted in a broad manner, consistent with the present disclosure.

What is claimed is:

1. A method for configuring a behavior of an application on a mobile device via configuration parameters maintained by an application control program supported by a system operating on a network accessible platform, the method comprising:
receiving, by the system, the application;
receiving, by the system, a program name to be assigned to the application;
assigning, by the system, a network address, a user name, and a password to the program name, wherein the network address, user name, and password are to be used by the application on the mobile device to communicate with the application control program;
receiving, by the system, at least one file containing configuration parameters to be used by the application control program in controlling the application on the mobile device;
building, by the system, at least one database table based on the at least one file, wherein the at least one database table is accessible to the application control program;
building, by the system, an entry screen based on the at least one database table; and
linking, by the system, the entry screen to login information corresponding to an account on the system, wherein the entry screen is configured to provide access to the configuration parameters when the system is provided with the login information.

2. The method of claim 1 further comprising:
receiving, by the application control program from the application on the mobile device, authentication information including the user name and password; and
sending, by the application control program, the configuration parameters to the application on the mobile device.

3. The method of claim 2 further comprising:
receiving, by the application control program, a request from the application on the mobile device for a service not provided by the system; and
sending, by the application control program, information to the service for the application on the mobile device.

4. The method of claim 3 further comprising:
receiving, by the application control program, information from the service for the application on the mobile device; and
sending, by the application control program, the information from the service to the application on the mobile device.

5. The method of claim 4 wherein all communications between the application on the mobile device and the service pass through the application control program.

6. The method of claim 1 further comprising receiving, by the system, instructions for the creation of a multi-level hierarchy having at least a first level of authority and a second level of authority, wherein the first level of authority is authorized to set and lock a first configuration parameter and wherein the second level of authority cannot modify the first configuration parameter if the first configuration parameter has been locked by the first level of authority.

7. The method of claim 6 wherein the instructions for the creation of the multi-level hierarchy are included in the at least one file.

8. The method of claim 1 wherein at least one of the received configuration parameters identifies a service not provided by the system, and wherein the method further comprises formatting the at least one received configuration parameter pursuant to an application programming interface corresponding to the service.

9. The method of claim 1 further comprising providing, by the system, a second set of configuration parameters for the application on a second mobile device, wherein the second set of parameters alters the behavior of the application on the second mobile device compared to the behavior of the application on the first mobile device.

10. A method for dynamically modifying a behavior of an application on a mobile device via configuration parameters accessible to an application control program provided on a network accessible platform separate from the mobile device, the method comprising:
linking, on the network accessible platform, authentication information with a plurality of accounts, wherein each account is associated with a financial identifier and unique presentation information that customizes an appearance of the application on a display of the mobile device for each account;
receiving, by the network accessible platform, the authentication information from the application on the mobile device, wherein the authentication information identifies the application as being authorized to access the plurality of accounts on the network accessible platform;
receiving, by the network accessible platform, identifying information from the application;
identifying, by the network accessible platform, a first account of the plurality of accounts based on a comparison of the identifying information with configuration parameters for the application stored on the network accessible platform;
sending, by the network accessible platform, the presentation information corresponding to the selected first account to the application on the mobile device;
receiving, by the network accessible platform, financial transaction information corresponding to a financial transaction from the application;
associating, by the network accessible platform, the financial transaction information with the first account and the financial identifier associated with the first account;
creating, by the network accessible platform, a financial transaction record based on the financial transaction information; and
sending, by the network accessible platform, at least a portion of the financial transaction record to a financial transaction server for processing.

11. The method of claim 10 wherein the identifying information includes location information identifying a location of the mobile device, wherein each of the accounts is associated with a unique location, and wherein the first account is identified based on a proximity of its location to the location of the mobile device compared to the locations of the other accounts.

12. The method of claim 10 further comprising:
receiving, by the network accessible platform, a request from the application for accounts corresponding to an account identified in the request;
identifying, by the network accessible platform, at least a subset of the accounts corresponding to the identified account that the application is authorized to access; and
sending, by the network accessible platform, the subset of accounts to the mobile device,
wherein the identifying information received from the application identifies user selection of the first account.

13. The method of claim 10 further comprising determining, by the network accessible platform, whether the financial transaction information indicates that the financial transaction exceeds a transaction limitation defined by at least one configuration parameter.

14. The method of claim 13 wherein the transaction limitation is a maximum total transaction value for a defined period of time.

15. The method of claim 13 wherein the transaction limitation is defined to allow the financial transaction only within a defined geographic area.

16. The method of claim 13 wherein the transaction limitation is defined to allow the financial transaction only within a defined period of time.

17. The method of claim 13 further comprising sending, by the network accessible platform to the application, a rejection message if the financial transaction exceeds the transaction limitation.

18. The method of claim 13 further comprising sending, by the network accessible platform to the application, an approval message if the financial transaction does not exceed the transaction limitation.

19. The method of claim 10 wherein the unique presentation information includes branding information.

20. The method of claim 10 wherein the configuration parameters for the application stored on the network accessible platform correspond to one of a plurality of hierarchical authorization levels for the application defined on the network accessible platform.

21. A method for verifying a payment for an electronic transaction comprising:
receiving access, by a gateway server, to authentication information corresponding to an electronic wallet account that stores a plurality of payment types that are available to an application on a mobile device, wherein the authentication information includes identification information that is uniquely linked to the mobile device;
receiving, by the gateway server, an approval request for an electronic transaction from a merchant, wherein the approval request indicates that the application has supplied payment information corresponding to one of the payment types to the merchant, and wherein the approval request includes the identification information linked uniquely to the mobile device;
verifying, by the gateway server, that the payment information and the identification information received with the approval request match the payment information and identification information corresponding to the electronic wallet account; and
sending, by the gateway server, an authorization request to the application on the mobile device, wherein the authorization request identifies the electronic transaction for which the authorization request is being sent.

22. The method of claim 21 further comprising:
receiving, by the gateway server, an approval from the application in response to the authorization request; and
notifying, by the gateway server, the merchant that the electronic transaction has been approved in response to receiving the approval from the application.

23. The method of claim 21 wherein the identification information received with the approval request represents at least one information type of bar code information, near-field communication (NFC) information, radio-frequency identification (RFID) information, or Smart Chip information.

24. The method of claim 21 wherein the identification information includes location information identifying a current location of the mobile device and wherein verifying, by the gateway server, that the identification information received with the approval request matches the identification information corresponding to the electronic wallet account further includes determining whether the application is permitted to perform the electronic transaction at the current location of the mobile device.

25. The method of claim 24 further comprising:
providing, by the gateway server, a plurality of accounts to the application, wherein the electronic wallet account is one of the plurality of accounts; and
providing, by the gateway server, the plurality of the payment types to the application in response to receiving a selection indicator from the application that the electronic wallet account has been selected.

26. The method of claim 25 further comprising providing only a subset of the payment types to the application based on the current location.
